(19) United States
(12) Patent Application Publication
(10) Pub. No.: US 2012/0101900 A1
(43) Pub. Date: Apr. 26, 2012

(54) PATRON SERVICING USING A COMMUNICATIONS NETWORK

(76) Inventors: Gerald E. Milatz, Traverse City, MI (US); Karen A. Milatz, Traverse City, MI (US)

(21) Appl. No.: 13/278,139

(22) Filed: Oct. 20, 2011

Related U.S. Application Data
(60) Provisional application No. 61/405,152, filed on Oct. 20, 2010.

(51) Int. Cl. G06Q 30/02; G06Q 50/12; G06Q 20/12; G06F 3/01; G06Q 30/06

(52) U.S. Cl. 705/14.55; 715/719; 705/27.2; 705/15; 705/14.73; 705/14.68; 705/14.69

(57) ABSTRACT

A method and system pertaining to providing service to patrons in an establishment using a communications network. The method and system include enabling access to the communications network by a patron using a patron computer having a user interface including a video display.

This is a nonprovisional patent application which claims the benefit of U.S. provisional patent application Ser. No. 61/405,152, filed on Oct. 20, 2010, the disclosure of which is incorporated herein by reference in its entirety.

### TECHNICAL FIELD

The present invention generally relates to communications and, more particularly, to electrical communications and telecommunications networks and related methods and software.

### BACKGROUND

Patrons at various types of establishments often must wait in seats, or in lines at concessions stands to order and receive products like food, souvenirs, and the like. Also, patrons may be reluctant or unable to attract attention of roaming vendors of a establishment. Additionally, although establishments may have large video screens to display live video, stored video, and video replays of an event taking place at the establishments, patrons may miss such video at any given moment. Likewise, television coverage of the event may not be available to patrons inside of certain types of establishments for various reasons. Moreover, although attempts have been made to make attendance at establishments more patron-interactive, some types of interaction may be insufficiently personal.

### SUMMARY OF THE INVENTION

A method and system pertaining to providing service to patrons in an establishment using a communications network. The method and system include enabling access to the communications network by a patron using a patron computer having a user interface including a video display.

### BRIEF DESCRIPTION OF THE DRAWINGS

FIG. 1 is a block diagram of an example embodiment of a patron servicing system;

FIG. 2 is a block diagram of an example embodiment of a system computer; and

FIG. 3A is an illustrative user interface page depicting instructions, terms, and conditions for the user interface.

FIG. 3B is an illustrative user interface page depicting a language selection for the user interface.

FIG. 4A is an illustrative user interface depicting a PIN recovery page.

FIG. 4B is an illustrative user interface depicting a prompt for authenticating information.

FIG. 4C is an illustrative user interface depicting an update account page.

FIG. 5 is an illustrative user interface page depicting an establishment service main menu for the user interface.

FIG. 6A is an illustrative user interface page depicting a selection of live video camera views.

FIG. 6B is an illustrative user interface page depicting a selection of instant replay videos.

FIG. 7 is an illustrative user interface page depicting a sponsor ad page.

FIG. 8A is an illustrative user interface page depicting a roaming vendor request page.

FIG. 8B is an illustrative user interface page depicting a roaming vendor confirmation page.

FIG. 9A is an illustrative user interface page depicting an order concessions login page.

FIG. 9B is an illustrative user interface page depicting an order concessions page.

FIG. 9C is an illustrative user interface page depicting an order concessions payment page.

FIG. 9D is an illustrative user interface page depicting an order concessions confirmation page.

FIG. 9E is an illustrative patron computer displaying a user interface page depicting an order concessions page.

FIG. 9F is an illustrative patron computer displaying a user interface page depicting an order concessions confirmation page.

FIG. 10A is an illustrative user interface page depicting a suite ordering menu login page.

FIG. 10B is an illustrative user interface page depicting a suite ordering menu page.

FIG. 10C is an illustrative user interface page depicting a suite ordering menu payment page.

FIG. 10D is an illustrative user interface page depicting a suite ordering menu confirmation page.

FIG. 11A is an illustrative user interface page depicting an order merchandise login page.

FIG. 11B is an illustrative user interface page depicting an order merchandise page.

FIG. 11C is an illustrative user interface page depicting an order merchandise payment page.

FIG. 11D is an illustrative user interface page depicting an order merchandise confirmation page.

FIG. 12 is an illustrative vendor interface depicting a text message displaying an order placed by a user.

FIG. 13A is an illustrative administrator interface page depicting both available and unavailable items for order.

FIG. 13B is an illustrative administrator interface page depicting a plurality of patron orders.

FIG. 13C is another illustrative administrator interface page depicting a plurality of patron orders.

FIG. 13D is an illustrative administrator interface page depicting categorized patron orders.

FIG. 14A is an illustrative administrator interface depicting assignable vendor areas.

FIG. 14B is an illustrative administrator interface depicting sections of an establishment assigned to vendors areas.

FIG. 14C is an illustrative administrator interface depicting a selectable menu of vendor areas.

FIG. 15 is an illustrative administrator interface depicting a menu for generating revenue reports.

FIG. 16 is an illustrative advertisement.

FIG. 17 is an illustrative administrator interface depicting an upload menu for advertisements.

FIG. 18 is an illustrative user interface depicting an upload menu for patron images and videos.

FIG. 19A is an illustrative user interface depicting an establishment map.

FIG. 19B is an illustrative user interface depicting scroll and zoom functions with an establishment map.

FIG. 20 is an illustrative user interface depicting a patron feedback page.

FIG. 21 is an illustrative user interface depicting closed caption.

FIG. 22 is an illustrative user interface depicting an emergency page.

FIG. 23 is an illustrative user interface depicting a login or profile menu.

### DETAILED DESCRIPTION OF THE PREFERRED EMBODIMENTS

In general, methods will be described using one or more examples of illustrative embodiments of a patron servicing system to facilitate provision of services for patrons using a communication network. The methods generally may include making live and stored video available to a patron using a patron computer at the establishment, receiving and processing requests for products and services from the patron via the patron computer, displaying advertisements to the patron via the patron computer at the establishment, and/or displaying visual data received from the patron on a video display at the establishment.

The example embodiments will be described with reference to their use in an illustrative patron servicing system. However, it will be appreciated as the description proceeds that the invention is useful in many different applications and may be implemented in many other embodiments. In this regard, the system description below is merely illustrative of one example, and the methods may be used in any suitable environment with any suitable systems, hardware, software, firmware, and/or the like. It should be understood that the disclosed method may be used with any number of different systems and is not specifically limited to the operating environment shown here. Thus, the following description simply provides a brief overview of one such illustrative system; however, other systems not shown here could employ the disclosed methods as well.

System

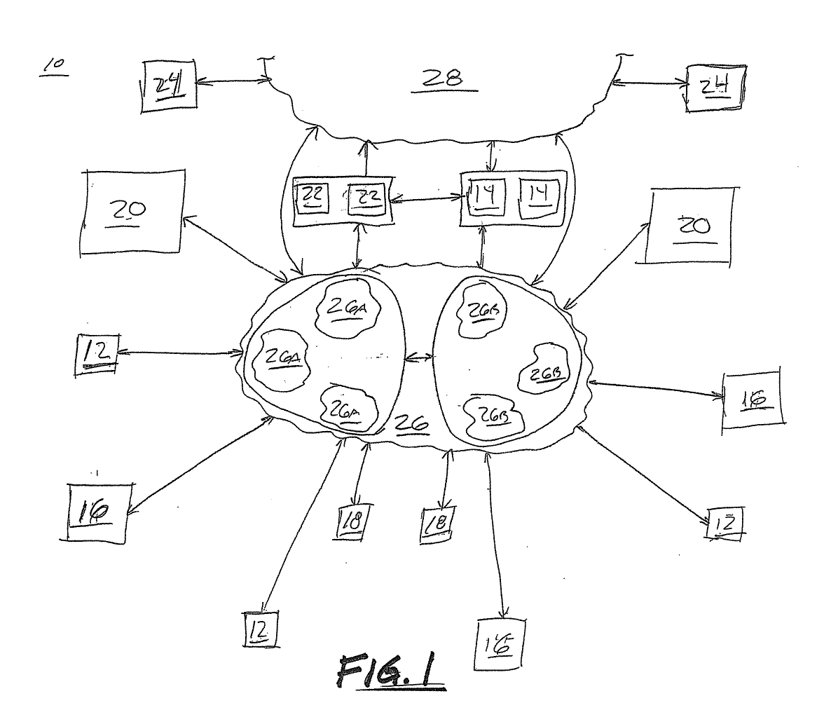

Referring specifically to the drawings, FIG. 1 illustrates an illustrative embodiment of an operating environment in the form of a system 10 that may be used to implement computer-assisted methods of providing establishment related services to a patron using a communications network. The system 10 may be used with at least one of the following entities: patrons, system administrators, vendors, web-hosts, or third party enablers. The system 10 may include the following subsystems, system elements, or system components, to receive, process, and transmit data: one or more patron computers 12, one or more administrator computers 14, one or more vendor computers 16, one or more system input devices 18, one or more system output devices 20, one or more web-hosting computers 22, and/or one or more third party computers 24, and a communication network 26 to provide communication among and between one or more of the aforementioned other system elements. The communication network 26 may include one or more wireless networks 26A, one or more wired networks 26B, and/or the Internet 28.

Patrons

The patrons may be in any suitable location at the establishment. For example, the patrons may be located in seats, in common areas of the establishment, and/or any other suitable locations. In another example, for some types of establishments, the patrons may be located in areas outside of but adjacent to the establishment. As used herein, the term “establishment” may include a vehicle of any kind including an airplane or train or any other suitable vehicle, and also may include a store, restaurant, arena, stadium, race track, field, court, course, auditorium, theater, performing arts center, hall, convention center, and/or any other suitable gathering place, for example, to travel, or observe or participate in an event or the like. Also, as used herein, the term “patrons” may include travelers, customers, trade show exhibitors, spectators, fans, observers, attendees, and/or any other suitable people. In some embodiments, the patrons are in attendance at the establishment, for example, to observe or participate in an event or the like at the establishment. In other embodiments, the patrons may not be in attendance at the establishment and, instead for example, may be observing the event at the establishment via television, Internet, radio, and/or any other suitable medium.

The patrons may use the patron computers 12 to receive one or more of a variety of services. In general, the patron computers 12 may enable patron enrollment or registration, patron servicing, and/or communication with the other elements 14 through 24 of the system 10. The patron computers 12 may be fixed or mobile products and may include personal mobile smart phones, other mobile telephones, tablet computers, laptop or notebook computers, establishment computers located at seats or kiosks of the establishment, and/or any other suitable products. In one embodiment, the patron computers 12 are owned by the patrons. In another embodiment, the patron computers 12 are rented to the patrons by the establishment, the system administrator, a third party, and/or any other suitable entity. In a further embodiment, the patron computers 12 are provided for patron use at the establishment free of charge by the establishment, the system administrator, a third party, and/or any other suitable entity. In particular, the patron computers 14 may be configured to store and process data and computer-readable media that may include data and/or computer application programs. Specific, non-limiting examples of the patron computers 12 may include BLACKBERRY, ANDROID, iPHONE, PALM, and/or any other suitable brand(s) of communication devices.

System Administrator

The system administrator may include one or more physical locations, for example, a data processing center, office, station, or the like, and may or may not be located in, or at, the establishment. The system administrator and the web-host may be located in the same or different facilities. As used herein, the terminology “system administrator” may include a establishment owner and/or operator, a third party contractor, a telecommunications company, a media company, and/or any other suitable entity to provide system administration.

The system administrator may include one or more of the administrator computers 14 and one or more live system representatives, managers, and/or the like. The administrator computers 14 may include desktop computers, network servers, laptop computers, and/or any other suitable computing device(s). In particular, the administrator computers 14 may be configured to store and process data and computer-readable media that may include data and/or application programs.

Vendors

Vendors may be fixed in any suitable locations at the establishment, or may be roaming any suitable locations at the establishment. As used herein, the term “vendors” may include stewards, attendants, concessionaires, merchandisers, caterers, suppliers, purveyors, security, medical professionals, emergency assistance, and/or any other suitable individual and/or organization to provide goods and/or services to the patrons. As used herein, the term “concessions” may include food, beverages, merchandise, and/or any other suitable product or service available for purchase or rental at a establishment.

The vendors may use the vendor computers 16 to interact with the patron computers 12 and/or any other elements of the system 10. In one embodiment, the vendor computers 16 may include point-of-sale (POS) terminals or computers, or desktop computers at fixed locations in the establishment. In another embodiment, the vendor computers 16 may include mobile devices, for instance tablet computers, for vendors who roam the establishment. In particular, the vendor computers 16 may be configured to store and process data and computer-readable media that may include data and/or application programs. Moreover, the vendors may use other devices; e.g., any suitable input and/or output devices. More specifically, the vendors may use vendor data input devices, for instance, bar code scanners for reading product codes, credit card charging devices for charging patron credit cards, and the like.

Web-Host

The web-host may be located at the establishment or in any other suitable location. As used herein, the term web-host may include website service, web page hosting service, and/or any other suitable Internet content hosting service that may be owned or controlled by the system administrator, a third party, and/or the like.

The web-host may include the web-hosting computers 22 that may include any suitable web servers using any suitable software architecture, for example, a high availability architecture that may be run on Sun® brand computers or on custom-constructed or any other suitable computing equipment, and may be enabled by Linux, Apache Webserver, MySQL database, PHP, Java, Joomla!, and/or any other suitable application programs and/or web services. In one embodiment, the web-host computers 22 may be the same as the administrator computers 14.

Third Party Enabler

The third party enabler may be located at the establishment or remotely therefrom. As used herein, the terminology “third party enabler” may include external service providers, business facilitators, and/or any other entity that may enable one or more features of the presently disclosed methods.

The third party enabler may include the third party computers 24 for receiving and transmitting data from and to other portions of the system 10 via the communications network 26. One example of a third party enabler is the well known PayPal® system. Another example of the third party enabler is a credit card charging system. A further example of the third party enabler is a data center, for instance, a Research In Motion data center for the BLACKBERRY network. An additional example of the third party enabler is the well known Ticket Master® system.

Communication Network

The communication network 26 may include any suitable local area network, wide area network, which may include the Internet 28, and/or the like. The communication network 26 may include any wireless network, land network, or any combination thereof, that is adapted to transmit and receive signals to and from one or more of the other elements 12 through 24 of the system 10. In one embodiment, the system elements may communicate using web-page interfaces using hypertext transport protocol (HTTP), transport-control protocol and Internet protocol (TCP/IP), and/or any other suitable communication standard(s). Moreover, network browsers, for example FIREFOX, INTERNET EXPLORER, and/or any other suitable browsers, may be used as interfaces loaded to the patron computers 12 and/or one or more of the other system elements for carrying out at least portions of the methods described herein.

The wireless network 26A may include at least a portion of a wireless communications carrier, a mobile telephone system, a satellite broadcast system, and/or the like, that incorporates any type of telecommunications in which electromagnetic waves carry signals over part of or an entire communication path. In one implementation of the wireless network 26A, it may also or instead include any suitable hardware, software, and/or firmware to communicate wirelessly according to one or more of IEEE 802.11 WiFi protocols, WiMAX, Bluetooth, and/or any other suitable wireless protocols. In a related implementation, the wireless network 26A may include a mobile ad hoc network (MANET), wireless ad hoc network, wireless mesh network, or the like, that may include two or more patron computers 12, vendor computers 16, and/or the like.

In another implementation, the wireless network 26A may include a cellular system that includes a plurality of cell towers, one or more mobile switching centers, as well as any other networking components required to connect the wireless network 26A with the wired network 26B. The wireless network 26A can implement any suitable communications technology, including for example, analog technologies (e.g. AMPS3) and/or digital technologies (e.g. GSM/GPRS, CDMA, CDMA2000, OFDMA, 3G, 4G, 5G, etc.). Data may be sent either via a data connection, e.g., via packet data transmission over a data channel, or via a voice channel using suitable techniques. For combined services that involve both voice communication and data communication, the system 10 may use calls over voice channel and may switch as needed between voice and data transmission over the voice channel, and this may be done using any suitable techniques.

The wired network 26B may include a land network used to connect at least two of the various system elements 12 through 24. For example, the land network may include a public switched telephone network (PSTN) to provide hardwired telephony, packet-switched data communications, and/or Internet infrastructure. In other examples, the land network may include an Internet protocol (IP) network, fiber optic network, and/or any combination thereof. The land network may be connected to one or more landline telephones, facsimile machines, computers, or the like. One or more segments of the land network could be implemented through the use of a standard wired network, a fiber or other optical network, a cable network, power lines, other wireless networks (e.g., wireless local area networks (WLANs)), or networks providing broadband wireless access (BWA), or any combination thereof.

System Computers

Those of ordinary skill in the art will recognize that the various computers 12, 14, 16, 22, 24 of the system 10 may have hardware, firmware, and/or software aspects in common. Therefore, the following general description of one or more computers is generally applicable to the computers 12, 14, 16, 22, 24 so that individual descriptions of those computers are not repeated to avoid unduly burdensome reading. To the extent the other system elements 18, 20 have computing devices, the following description is also applicable thereto.

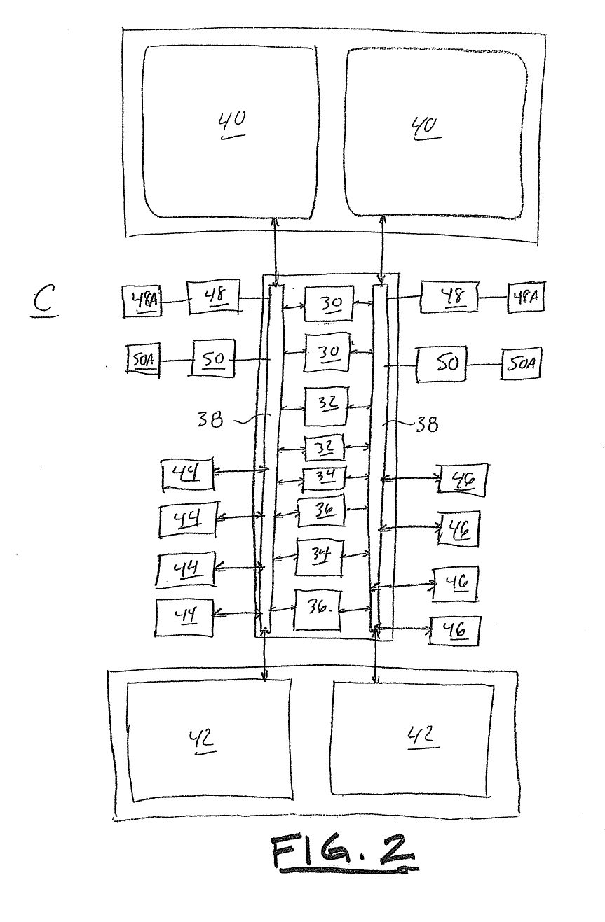

Referring now to FIG. 2, the computers C may be implemented as any suitable hardware, software, and/or firmware to carry out any suitable functions. For example, the computers C may include one or more processors 30 to process data and programs, internal memory 32 to store data and programs, one or more input interfaces 34 to enable or facilitate communication or control between other computer elements, one or more output interfaces 36 to enable or facilitate communication or control between other computer elements, and one or more communication subsystems 38 to couple the various computer elements together. The computers C also may include a user interface, which may include one or more display output devices 40 to transmit data in visual form to a computer user, and/or one or more manual input devices 42 to receive manual input from a computer user. Also, the computers C may include one or more other input devices 44 and/or output devices 46, one or more wireless communication devices 48 and associated antennas 48A of any suitable type, and one or more wired communication devices 50 and associated connectors 50A of any suitable type. In some embodiments, the various elements of the computers C may be integrated into a single product. In other embodiments, the various elements of the computers C may be distributed among two or more separate but communicable products.

The processors 30 may be configured to execute control logic that provides the functionality for at least a portion of the computer C and/or to process telecommunications signals. In this respect, the processors 30 may encompass one or more processing units, controllers, microprocessors, micro-controllers, discrete logic circuit(s) having logic gates for implementing logic functions on data signals, application specific integrated circuits (ASIC) with suitable logic gates, complex programmable logic devices (CPLD), programmable or field-programmable gate arrays (PGA/FPGA), and/or the like. The processors 30 may be interfaced with the memory 32, which is any suitable media or medium configured to provide at least temporary storage of data and/or computer software or computer-readable instructions that provide at least some of the functionality of the system 10 and that may be executed by the processors 30. As used herein, the term processor also includes any ancillary devices; e.g., clocks, power supplies or transformers, and the like.

The memory 32 may include computer-readable media, which may include computer storage media, communication media, or any combination thereof. The computer storage media may be in the form of volatile memory and/or non-volatile memory that may be removable and/or non-removable, and may be implemented in any method or technology for storage of information; e.g., computer-readable instructions, program modules, data structures, other data, and the like. Illustrative volatile memory may include random access memory (RAM), static RAM (SRAM), dynamic RAM (DRAM), double data rate synchronous dynamic random access memory (DDR SDRAM), and/or any other suitable memory, for example, for storing software and data. RAM typically contains data and/or program modules that are immediately accessible to and/or presently being operated on by the processors 30. By way of example, and not limitation, the volatile memory may include an operating system, application programs, other memory modules, and data. Illustrative non-volatile memory may include read only memory (ROM), erasable programmable ROM (EPROM), electrically erasable programmable ROM (EEPROM), dynamic read/write memory (e.g. magnetic or optical disks or tapes), and/or static read/write memory (e.g. flash memory), and/or any other medium that may be used to store data and/or programs and that may be accessed by a computer. A basic input/output system (BIOS) may be stored in ROM for containing basic routines that help to transfer information between elements within the computers C, e.g., during computer startup.

Communication media may embody computer-readable instructions, program modules, data structures, other data, and the like, in a compressed or uncompressed data signal (e.g., a carrier wave or other transport means), and include any information delivery media. Those skilled in the art are familiar with modulated data signals, which have one or more characteristics set or changed in such a manner as to encode information in the signals. In any event, illustrative computer-readable signals, whether modulated using a carrier or not, are signals that a computer system hosting or running a computer program may be configured to access, including signals downloaded using the Internet or other networks. Examples of communication media include a wired network or direct-wired connection, and wireless media (e.g., acoustic, RF, infrared, and other wireless media).

The computers C also may include or be coupled to other data storage or media of any suitable type(s). For example, although not shown in the figures, a mass external storage read/write device may be used in the form of a dynamic read/write hard disk drive that may read from or write to non-removable, non-volatile magnetic media, or a dynamic read/write device (e.g. magnetic drive, optical drive, etc.) that reads from and writes to a removable, non-volatile element (e.g. magnetic floppy disk, magnetic tape cassette, digital versatile disk, digital video tape, optical disk, other storage media, etc.). Moreover, a static read/write device may be used in the illustrative operating environment for use with a static read/write product including, but not limited to, flash memory, integrated circuit chip, and/or any other suitable memory.

The memory enables storage and communication of computer-readable instructions, data structures, program modules, and/or other data for the computers C. For example, the mass storage device may store an operating system, application programs, other program modules, and program data. Note that the aforementioned items either may be the same as or different from the operating system, application programs, other program modules, and data of the internal memory 32 of the computers C. It is recognized, however, that such items may reside at various times in different storage media associated with the computers C, and may be executed by the processors 30. Those of ordinary skill in the art will recognize that suitable computer programs may be installed or loaded into a secondary memory of the computers C (e.g., mass storage, dynamic storage, or static storage). Upon execution by the processors 30, such computer programs may be loaded at least partially into a primary memory (e.g., the internal memory 32). Any suitable non-volatile memory interface may be used to connect the mass storage device and other memory to the communication subsystems 38.

The interfaces 34, 36 may include any suitable forms of electronic devices or adapters, or software modules or adapters, which enable one or more devices or computer elements to communicate with or control one or more other devices. The interfaces 34, 36 described herein all may be part of a single interface or may be implemented as separate interfaces or any combination thereof. The input interfaces 34 are provided to communicate with any suitable input devices, for instance, the input devices 44 and/or external input devices like memory, pointing devices (e.g., a mouse, trackball, pen, joystick, touch pad, touch screen, or the like), keyboard, modem, bar code or card reader, external microphone, satellite dish, scanner, and/or the like that may be used to communicate commands and/or data to the computers C. The input interface 34 preferably connects the above described input devices and possibly other input devices to the processors 30, preferably via the communication subsystems 38, but may be independently connected by other interfaces and bus structures, (e.g., via parallel port, Universal Serial Bus (USB), infrared device, or the like). The output interface 36 is provided to communicate with any suitable output devices, for instance, the output devices 46 or external peripheral output devices (e.g., printers, monitors, speakers, and/or the like), that may also be connected to the communication subsystems 38 via the interface 36.

The interfaces 34, 36 disclosed herein may conform to standard protocols, proprietary protocols, and/or any combination of standard and proprietary protocols. For example, the interfaces 34, 36 may conform to Ethernet or field bus protocol (e.g., Profibus, Interbus, Devicenet, RS-232, parallel, small computer system interface, USB, wireless protocols (e.g., Bluetooth, infrared, and/or the like, and/or to any other suitable input/output (I/O) protocols)). Moreover, an interface in the context of a software architecture may include a software module, component, code portion, or other sequence of computer-executable instructions. Such an interface may include, for example, a first module accessing a second module to perform computing tasks on behalf of the first module. The first and second modules may include, in one example, application programming interfaces (APIs) including those provided by operating systems, component object model (COM) interfaces (e.g., for peer-to-peer application communication), and extensible markup language metadata interchange format (XMI) interfaces (e.g., for communication between web services). The interfaces may be tightly coupled, synchronous implementations, e.g., Java 2 Platform Enterprise Edition (J2EE), COM, or distributed COM (DOOM) examples. Alternatively, or in addition, the interfaces may be loosely coupled, asynchronous implementations, e.g., a web service (e.g., using the simple object access protocol). In general, the interfaces 34, 36 may include any combination of the following characteristics: tightly coupled, loosely coupled, synchronous, asynchronous, and/or the like.

The communication subsystems 38 may couple the various elements of the computers C in any suitable manner. The communication subsystems 38 may provide for data transmission internally between each of the elements in the computers C, and externally between the internal elements of the computers C and any other elements external of the computers C. In one example, the communication subsystems 38 may include individual connections amongst the processors 30, memory 32, and interfaces 34, 36. In another example, as shown, the communication subsystems 38 may include system buses. The communication subsystems 38 may represent one or more of any of several types of bus structures, including a memory bus or memory controller, a peripheral bus, an accelerated graphics port, a processor or local bus using any of a variety of bus architectures, and the like. By way of example, and not limitation, such bus architectures may include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and/or the like.

The input and output devices 40 through 46 may be independent from one another or integrated in any suitable manner and combination. The display output devices 40 may include LCD, plasma, and/or any other suitable display to transmit data in visual form to computer users. The devices 40 may be passive output-only devices, and/or may include active input/output devices including touch screens for example. The display output devices 40 may communicate still or motion images, text, graphics, and/or any other suitable visual media. The manual input devices 42 may include keyboard, mouse, trackball, pen, joystick, touch pad, touch screen, and/or any other suitable devices to receive manual input from computer users. The other input devices 44 may include one or more microphones to receive data in aural form like speech or music, one or more memory ports to receive signals from external memory devices, one or more cameras to receive data in visual form like photographs or video, one or more accelerometers to receive data in motional form like acceleration, one or more positioners to receive data in positional form like global or local positioning coordinates, one or more magnetic sensors to indicate direction, one or more orienters to indicate orientation (e.g. a gyroscope), and one or more power sources to receive electrical power like batteries or fuel cells, or transformers. The other output devices 46 may include one or more loudspeakers to transmit data in aural form like music or speech, one or more memory ports to transmit signals to external memory devices, video connectors for coupling to external video devices, and audio connectors for coupling to external audio devices.

The wireless communication devices 48 may include wireless or radio frequency transmitters, receivers, and/or transceivers. More specifically, the wireless communication devices 48 enable wireless voice and/or data communication with the wireless communication network 26A so that at least some of the various system elements 12 through 22 can communicate with one another, and/or with some other system or non-system device(s). In one embodiment, the wireless communication devices 48 use electromagnetic radiation transmission, for instance, radio frequency, microwave, infrared, and/or the like.

In one example, the wireless communication devices 48 can establish a voice channel and/or a data channel with the wireless communication network 26A so that voice and/or data transmissions may be sent and received over the channel(s). The wireless communication devices 48 may use cellular communication according to GSM, CDMA, or any other suitable standards, and may include a cellular chipset for voice communications, a wireless modem for data transmission, an electronic processing device, one or more digital memory devices, and one or more of the antennas 48A. The wireless modem may be implemented through software stored in memory and executed by a processor, or may be a separate hardware component located internal or external to the computers C. The wireless modem can operate using any number of different standards or protocols including EVDO, CDMA, GPRS, EDGE, and/or the like.

In another example, one or more of the wireless communication devices 48 may be non-cellular devices to carry out wireless networking between the computers C and other networked devices. For this purpose, the wireless communication devices 48 may be configured to communicate wirelessly according to one or more other wireless protocols, e.g., any of the IEEE 802.11 WiFi protocols, WiMAX, Bluetooth, and/or the like. When used for packet-switched data communication (e.g., TCP/IP), the computers C may be configured with a static IP address or may be set up to automatically receive an assigned IP address from another device on the wireless network 26A, for instance, from a router or from a network address server.

The wired communication devices 50 may include modems, network interface cards, controllers, or converters. More specifically, the wired communication devices 50 enable wired voice and/or wired data communication over the wired communication network 26B so that at least some of the various system elements 12 through 24 can communicate with one another, and/or with some other system or non-system device. In one embodiment, the wired communication devices 50 may use electrical and/or optical transmission. For example, the wired communication devices 50 may include Ethernet devices, fiber optic devices, and/or the like.

The computers C may operate in a networked environment as shown, wherein software modules and/or data used by the computers C, or portions thereof, may be stored in other elements of the system 10 or a remote memory storage device or computer associated therewith or connected thereto. Also, the computers C may include additional elements or less elements than those described above.

In operation, the processors 30 may be powered by the power supply(ies) and may initially operate on instructions stored in the internal memory 32. The processors 30 may receive commands or data via one or more input devices, receive data and/or instructions from various storage media including the memory 32, process the data and/or instructions, and output data and/or instructions to other elements of the computers C and/or system 10. Generally, the processors 30 may carry out computer-executable instructions, (e.g., those associated with or embedded in software or computer programs including operating systems, application programs, and/or the like). Computer programs or software may include executable instructions for implementing logical functions and may be embodied in any computer-readable medium for use by or in connection with the processors 30 that can retrieve and execute the instructions. The software may include, but is not limited to routines, modules, objects, components, data structures, and/or the like, for performing particular tasks and/or implementing particular abstract data types. Computer programs may exist in a variety of forms both active and inactive. General examples include software programs comprised of instructions in source code, object code, executable code and/or other formats; firmware programs; hardware description language (HDL) files; and/or the like. Specific examples include assembler, C, C++ objects, Visual Basic, Visual C++, XML, Java, Microsoft® Foundation Classes, PERL, PHP, SQL, and/or the like. The system and methods described herein may use various types of computer-readable media, which may contain, store, and/or carry instructions or programs for implementing some or all of the method steps described herein in conjunction with the processors 30. At least some portion(s) of the methods may be practiced locally and/or in a distributed computing environment where tasks may be performed by remote computers or processing devices that are linked through the communications network 26. In a distributed computing embodiment, program modules may be located in both local and remote computer storage media including memory storage devices.

Methods

Described below is an illustrative method 200 of providing services for patrons of an establishment. Also, portions of the method 200 will be described in reference to the patron servicing system 10 of FIG. 1. The method steps may or may not be sequentially processed, and the presently disclosed inventions encompass any sequencing, overlap, or parallel processing of such steps. In addition, not all of the disclosed method steps need to be used. The method 200 or portions thereof may be embodied in one or more computer programs or software in any computer-readable medium for use by or in connection with the system 10 that may be stored in any suitable location, for example, in memory of the web-host computers 22, on the patron computers 12, on the administrator computers 14, on the vendor computers 16, and/or the like. Similarly, data used with or generated by any portion of the method 200 may be stored, for example, in one or more databases in any suitable location on the system 10, for example, in memory in one or more of in memory of the web-host computers 22, the patron computers 12, the administrator computers 14, the vendor computers 16, and/or the like. In other embodiments, software and databases may be distributed to any of the various elements, devices, or computers of the system 10. Moreover, any suitable network browsers may be used as interfaces loaded to one or more of the various system elements, devices, or computers for carrying out portions of the method 200.

At step 202, one or more patrons may enroll or register with a system computer. For example, a patron who desires to use one or more services and/or purchase one or more products from one or more vendors at the establishment may enroll or register with a system computer.

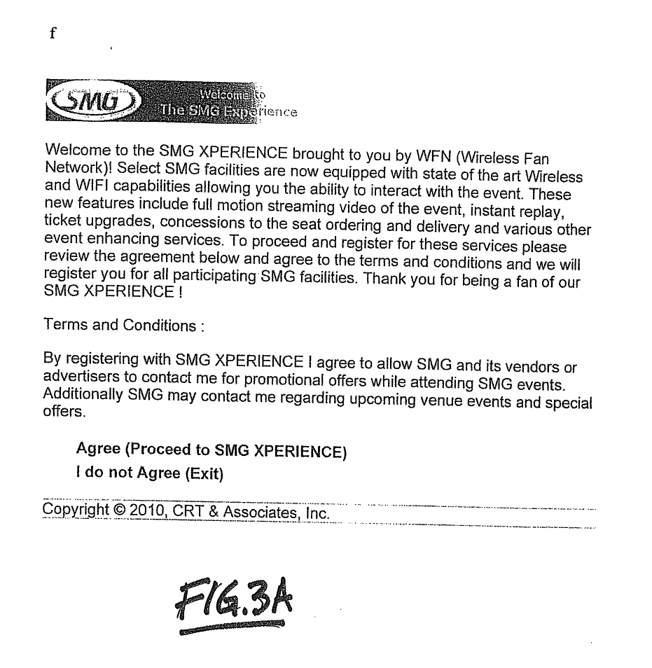

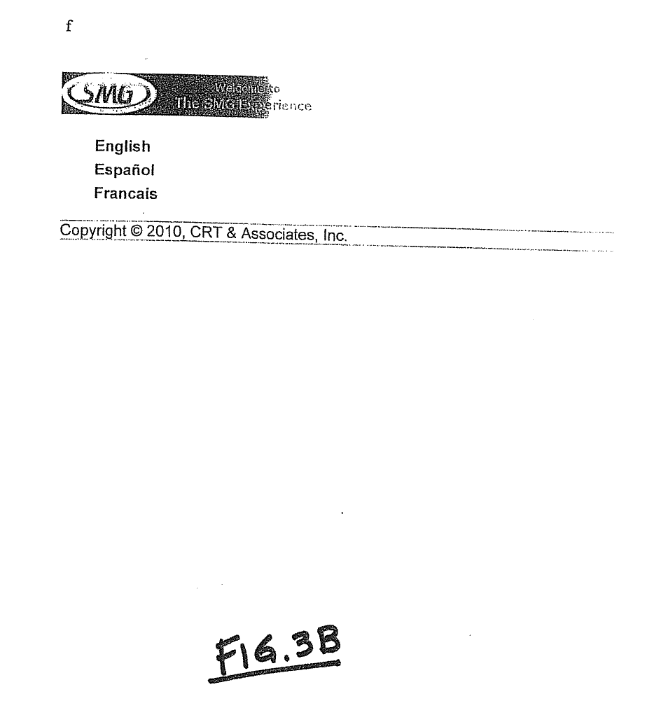

In one embodiment, the patron may use any suitable Internet browsing software loaded to the patron computers 12 to navigate to a registration page of a establishment service website that may be hosted by the web-host computers 22 associated with the system administrator. Once at the home page or any other suitable page of the website, the patron may view instructions, terms and conditions, and/or the like for using the establishment service website. An example user interface page is illustrated in FIG. 3A, depicting example instructions, terms, and conditions. If the patron desires to become enrolled or registered with the system 10, then the patron can navigate via hyperlinks or the like to an enrollment or registration page of the website to enter and submit patron identity, contact information, location at the establishment, and/or any other suitable information. An example language selection page is illustrated in FIG. 3B. The methods may be configured for use in any language including English, French, Spanish, German, Chinese, Japanese, or any other suitable languages.

In another embodiment, the patron may use any suitable Internet browsing software loaded to the patron computers 12 to navigate to a third party enabler like TICKET MASTER. For example, the patron may register with the system 10 when the patron purchases tickets for an event at the establishment. Accordingly, the third party enabler may register the patron and communicate the registration with the administration computers 14 so that the patron can be authorized or authenticated when the patron is present at the establishment for the event.

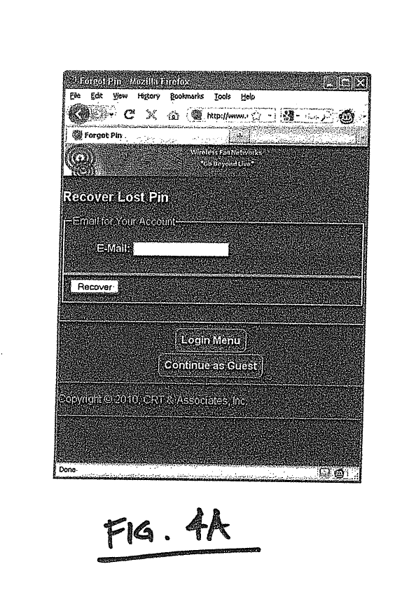

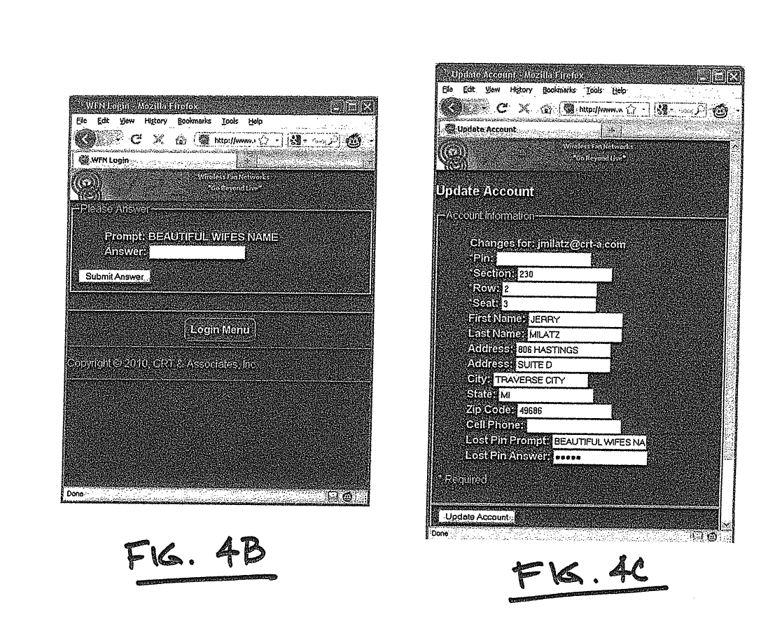

At step 204, a system computer may grant access to a establishment service function to a patron desiring to use the establishment service website. For example, once the patron's information is submitted in step 202, the administrator computers 14 may review and verify or refute the registration information and grant further access to the portal 22 if the information is verified. The registration information may be verified in any suitable manner, including manually by a human representative of the administrator. For example, registration of patrons may be verified or validated by telephone confirmation between the administrator and the patrons. Of course, registration may be verified automatically in any suitable manner including, for example, any well known PHP and/or JAVA techniques. Once verified, the administrator computers 14 may use the web-host computers 22 to authorize access of the patrons in any suitable manner. Upon granting access to the patrons, the web-host computers 22 may generate, store, and communicate to patrons, unique identifiers for the patrons (e.g., a personal identification number or PIN), and may register the patrons in association with their respective seat locations and/or identifiers. In one embodiment, the patron may be able to recover his or her unique identifier—e.g., in a situation where the patron is unable to provide the unique identifier to the webhost computer 22. Here, the patron may provide authenticating information to recover the identifier; such authenticating information may include patron identity, contact information, and/or any other suitable information (e.g., personal, confidential, or secret information known to the patron). For example, authenticating information may include one or more challenge answers to corresponding challenge questions. Challenge answers may include the patron's email and/or key information, e.g., the birth city of the patron, the patron's anniversary date, or a hint created by the patron during registration. See FIGS. 4A, 4B, and 4C.

At step 206, patrons may access or log in to a home page of the establishment service website. For example, once the patron has been registered by being verified and granted access to the establishment service website in step 204, then, in one embodiment, the patron may use their networked computer 14 to navigate via a hyperlink or the like to the home page of the establishment service website. In another embodiment, the patron may have to select a login function and, once selected, the patron may be navigated via hyperlink or the like by the portal 22 to a login screen where the patron may enter and submit a user name, password, and/or the like to gain further access to the website. The portal 22 may process the user name and password of the participant in any suitable manner, and navigate via hyperlink or the like the patron participant to a establishment service main menu page.

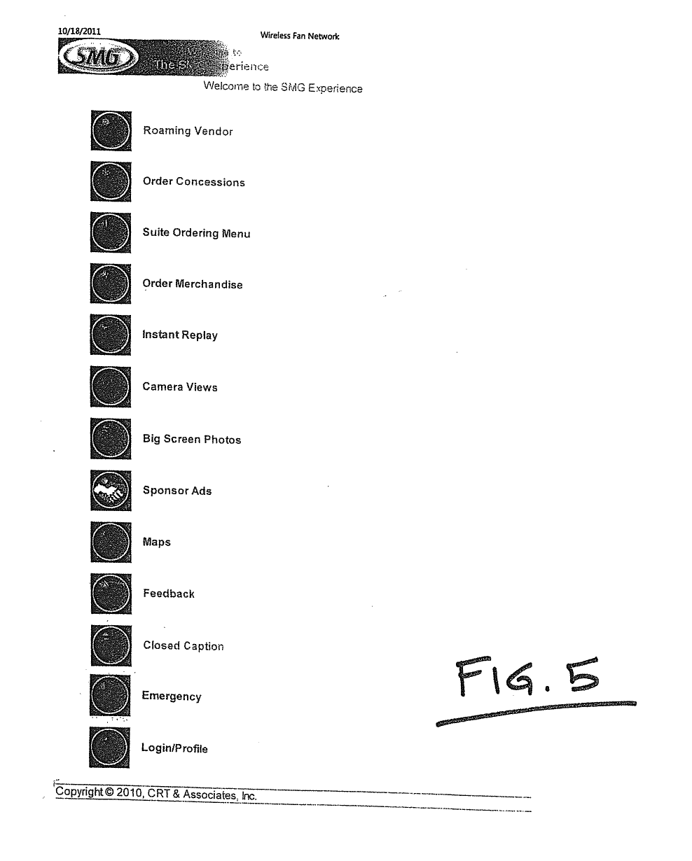

An example user interface page for a establishment service main menu is illustrated in FIG. 5. The main menu page may include graphical icons and adjacent text. A patron may select an icon and/or its corresponding text as a link to navigate to user interface pages for specific services.

At step 208, video may be captured. For example, the system input device(s) 18 may include one or more video cameras located at the establishment to capture video at the establishment. More particularly, the video cameras may include network television video cameras, professional sports league video cameras, and the like to capture at least portions of the event taking place at the establishment. In other particular examples, the video cameras may include video cameras located outside the establishment or at service areas of the establishment to provide real-time status of weather or traffic, lines at restrooms, concessions stands, and the like. In further particular examples, the video cameras may include establishment entertainment cameras, helmet mounted video cameras, backstage or locker room cameras, and the like.

At step 210, the captured video may be communicated over a communications network as live video. In one embodiment, the system input device(s) 18 may transmit the captured video to the administrator computers 14, which in turn may transmit the captured video to the patron computers 12 over the network 26. In another embodiment, the system input device(s) 18 may transmit the captured video to the patron computers 12 over the network 26.

At step 212, a plurality of videos may be stored in any suitable memory. In one embodiment, the captured and/or communicated video from steps 208 and/or 210 may be stored in memory of the administrator computers 14 or in any other suitable memory. In this embodiment, the stored video may be replay video, for instance, for availability to a patron on demand. In another embodiment, the plurality of videos may include pre-recorded video stored in memory, including movies, television shows, advertisements, and/or any other suitable video of interest to patrons. In other embodiments, the videos may include video clips from event participants, celebrities, or spokespersons, and/or public service announcement videos.

At step 214, a request from a patron may be received to view at least one of the plurality of videos stored at step 212. For example, the patron may submit the request using the patron computer user interface of one of the patron computers 12 to select at least one of the live video or the stored video for viewing. The video may be from the system input devices 18.

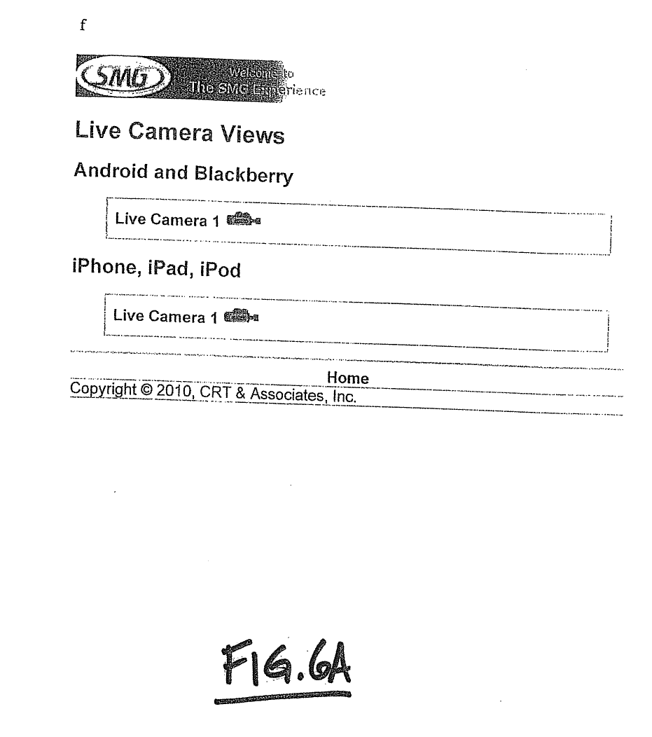

In a particular instance, the patron may access the main menu page of FIG. 5 and select the Camera Views text or icon. Upon selection, the patron is navigated to a camera views page. An example of a camera views page is illustrated in FIG. 6A. At the camera views page, the patron may identify the type of computer the patron is using, and/or may select one or more available camera views that may be represented by text and/or iconic links. In one embodiment, the system 10 may automatically identify what type of computer the user is using and make available camera views in a compatible video format.

In another particular instance, the patron may access the main menu page of FIG. 5 and select the Instant Replay text or icon. Upon selection, the patron is navigated to a view instant replays page. An example of a view instant replays page is illustrated in FIG. 6B. At that page, the patron may identify the type of computer the patron is using, and/or may select one or more available replays that may be represented by text and/or iconic links. In one embodiment, the system 10 may automatically identify what type of computer the user is using and make available instant replays in a compatible video format.

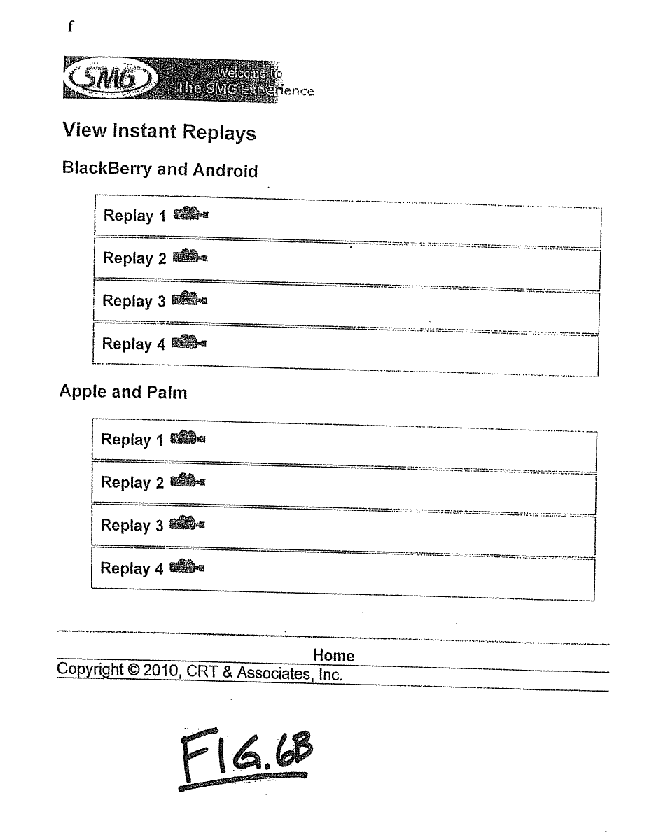

In another particular instance, the patron may access the main menu page of FIG. 5 and select the Sponsor Ads text or icon. Upon selection, the patron is navigated to a view sponsor ads page. An example of a view sponsors ads page is illustrated at FIG. 7. At that page, the patron may identify the type of computer the patron is using, and/or may select one or more available sponsor ads that may be represented by text and/or iconic links. In one embodiment, the system 10 may automatically identify what type of computer the user is using and make available video sponsor ads in a compatible video format.

At step 216, the live video and/or the stored video may be communicated or made available to the patron via the network 26 and video displays 40 of the patron computer user interface.

At step 218, a request or order for at least one of a product or service may be placed by a patron. For example, the request or order may be placed via the patron computer 12 and communications network 26. In one embodiment, the request may be for a roaming vendor. In another embodiment, the order may include an order for delivery from a concessions stand, or an order for a pick up from a concessions stand. In another embodiment, the request may be for a products or services to be delivered to a suite or similarly defined area at the establishment. And in yet another embodiment, the request may be for merchandise. For instance, the patron may access the main menu page of FIG. 5 and select the Roaming Vendor text or icon or the Order Concessions text or icon or the Suite Ordering Menu text or icon or the Order Merchandise text or icon.

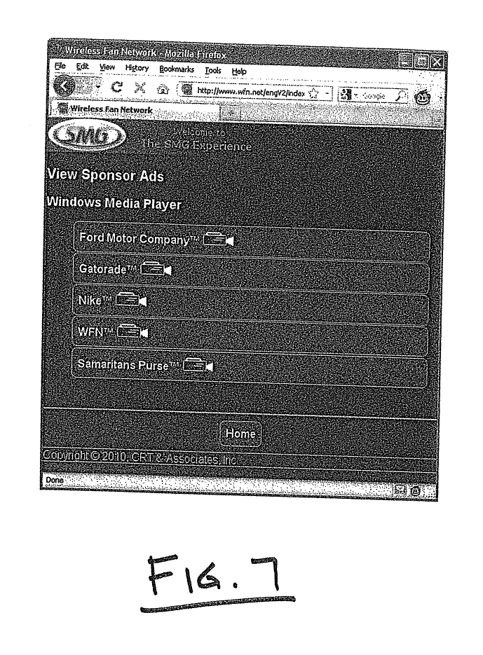

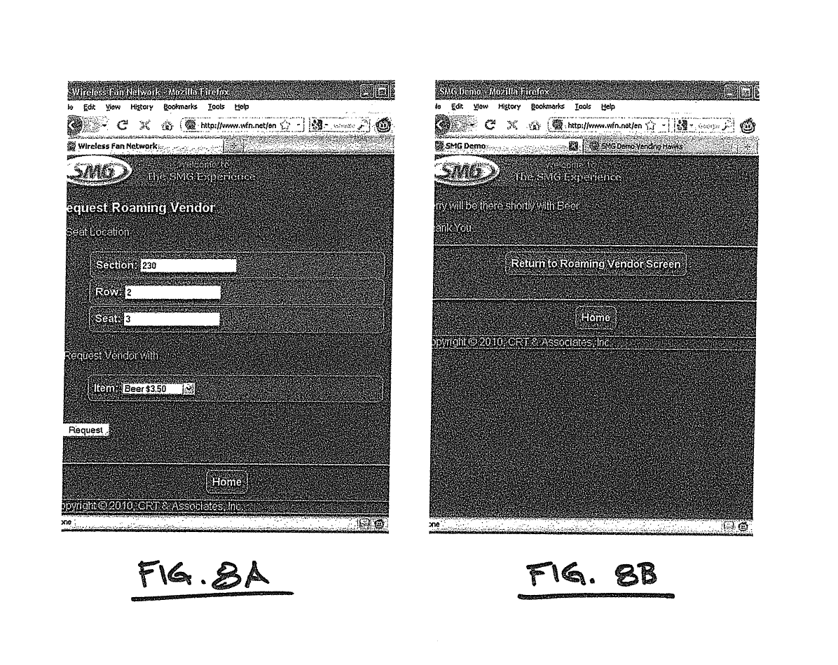

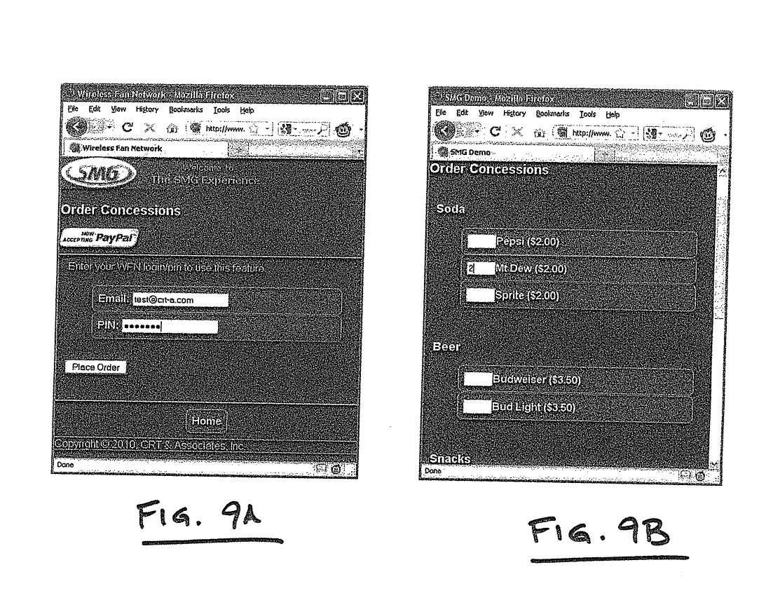

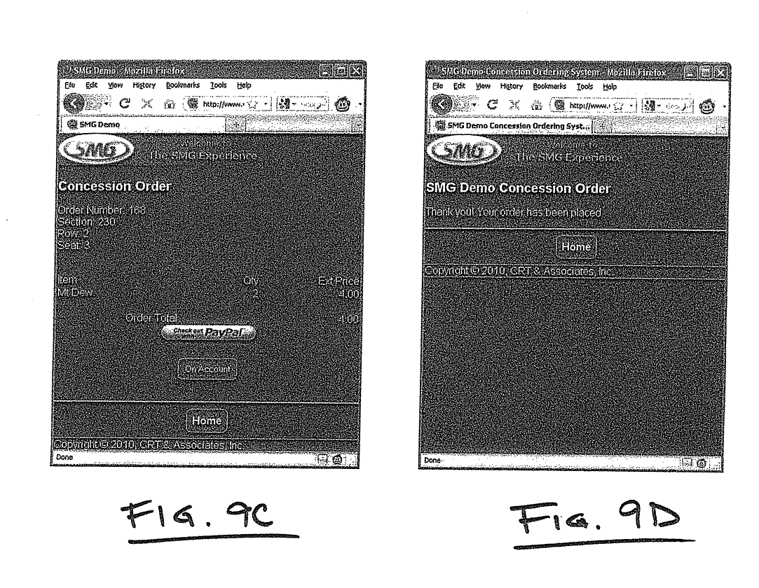

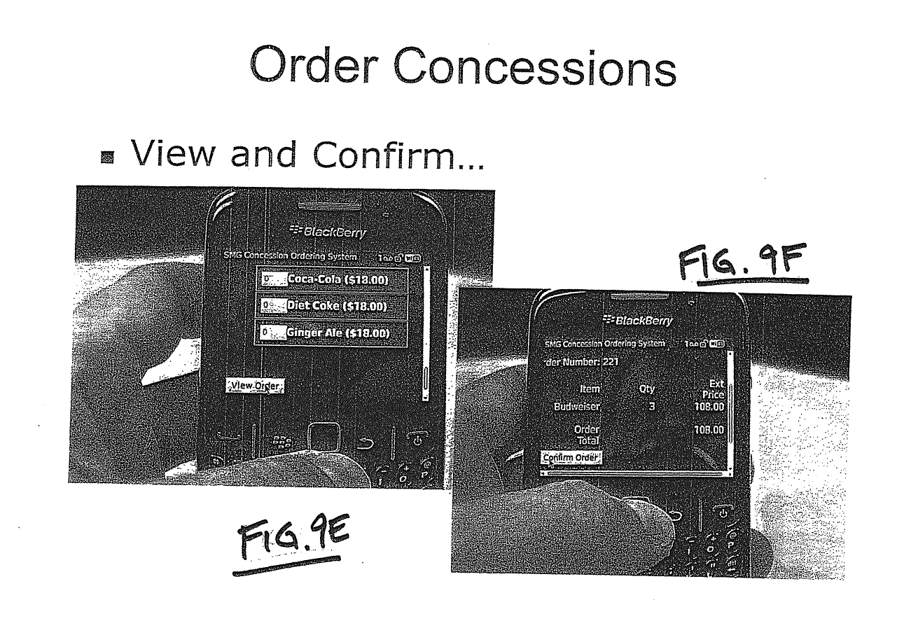

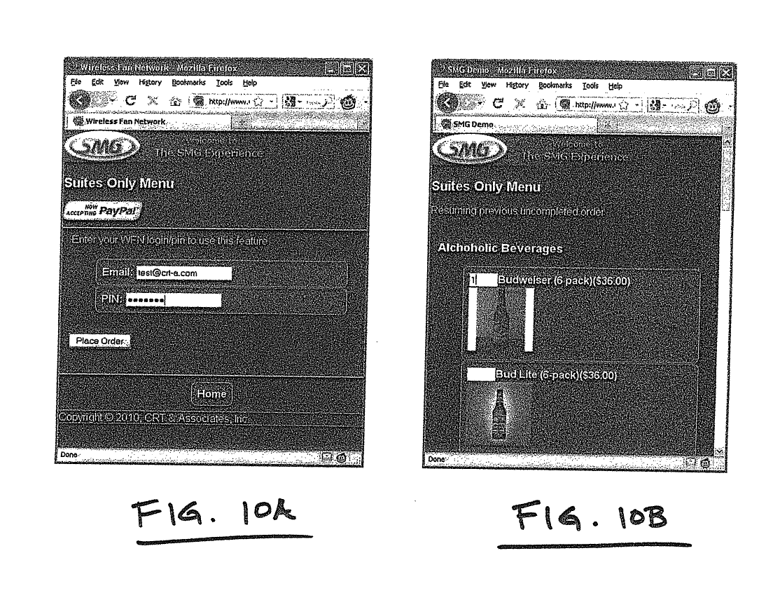

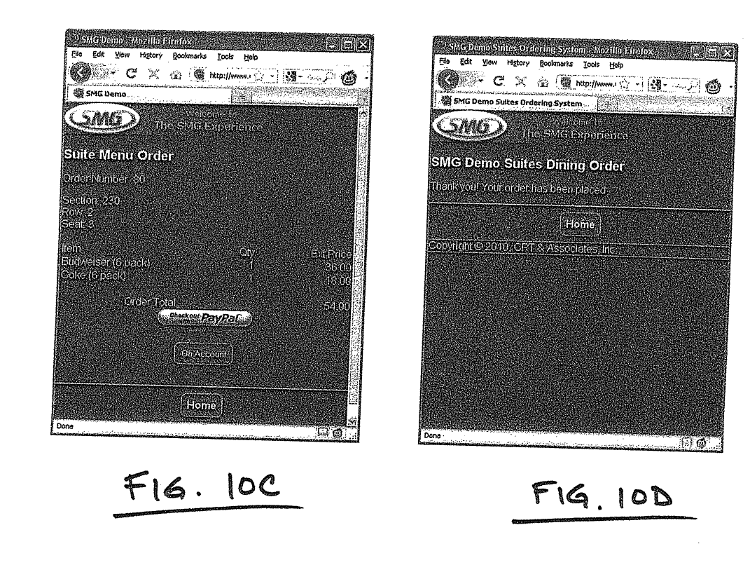

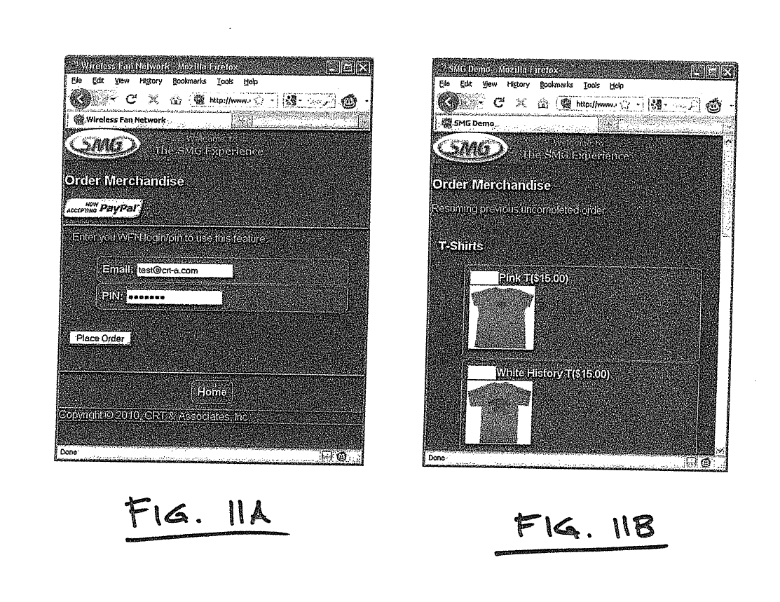

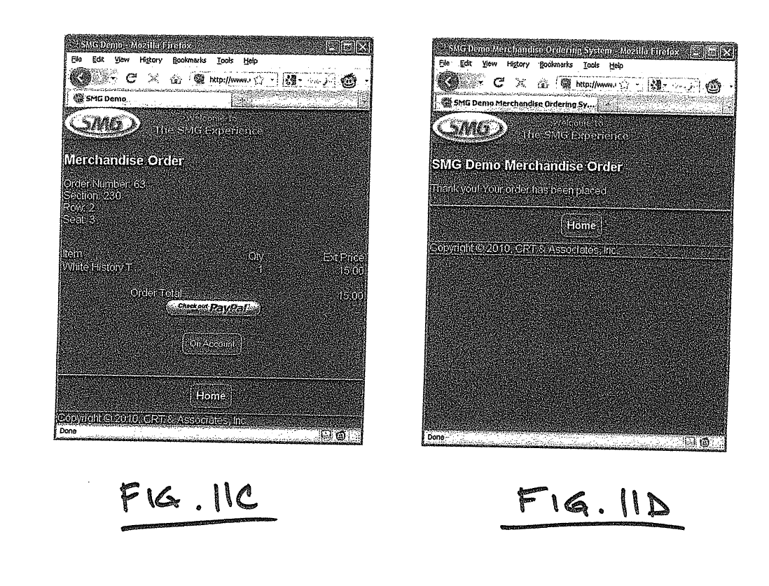

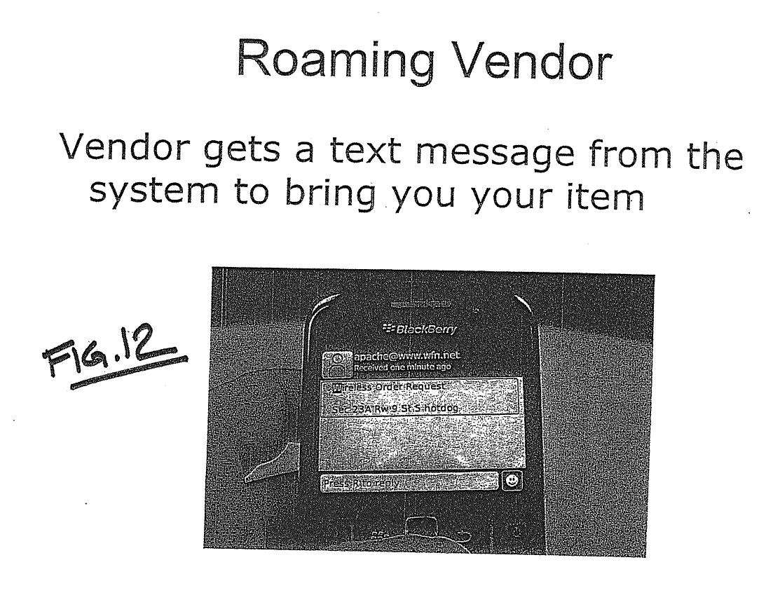

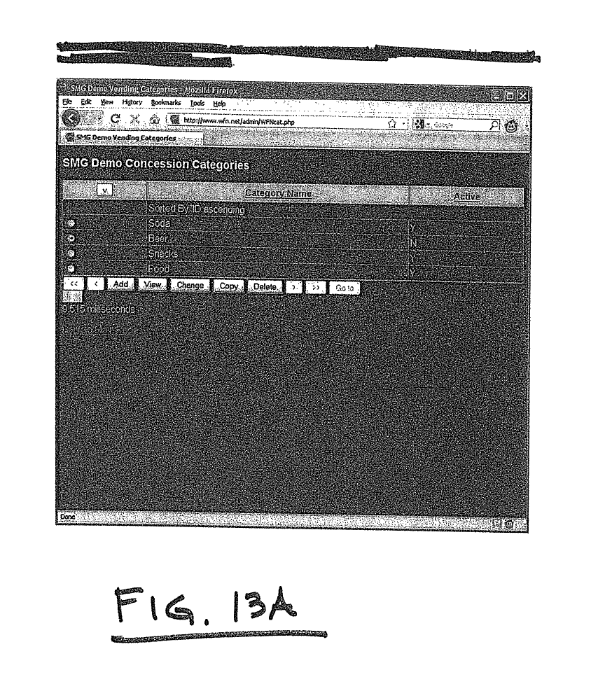

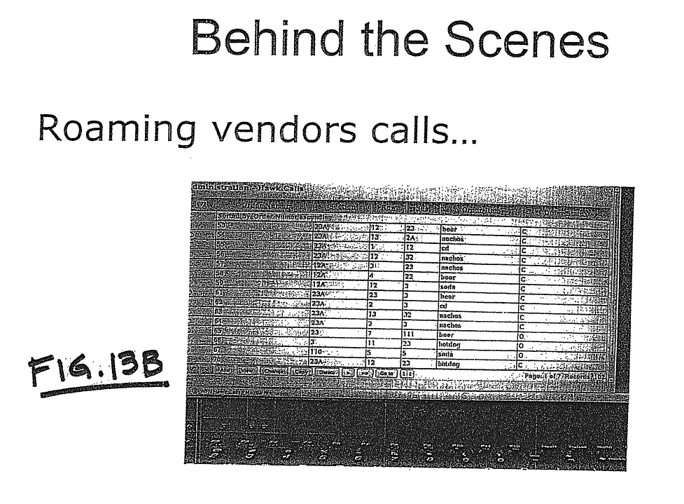

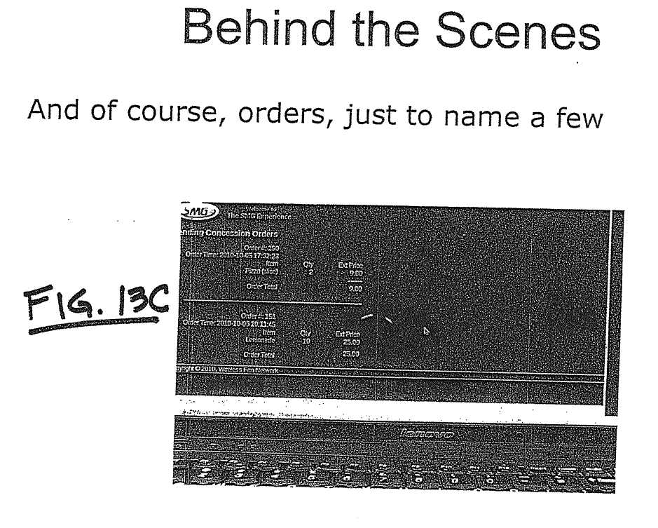

Upon selection, the patron may be navigated to one or more Request Roaming Vendor pages as exemplified by FIGS. 8A-8B, or to one or more Order Concessions pages as exemplified by FIGS. 9A-9F, or to one or more Suite Ordering Menu pages as exemplified by FIGS. 10A-10D, or to one or more Order Merchandise pages as exemplified by FIGS. 11A-11D. The request may include a location of the patron at the establishment as illustrated in FIGS. 8A. For example, the patron input a section, row, and seat location where the patron is located. At the Request Roaming Vendor page, the patron can also select a general type of item the patron desires, for instance, snack or beverage. In another embodiment, the patron can provide a more specific indication, for example, hot dog, chips, pop, beer, or the like. At the Order Concessions page, the patron can select a place order button or link, wherein the patron may be navigated to a menu ordering page having a menu or list of available items for purchase and prices, as exemplified by FIG. 9B. Accordingly, the patron may order one or more particular products on the menu. The patron also may select or specify that the order is for delivery or for pick up, for example, from a concessions stand. In one embodiment, the availability of items change during the course of an establishment event.

The patron may select a view order button or link as exemplified in FIG. 9E. As a result, the patron may be navigated to a order viewing page as exemplified by FIG. 9F, wherein the patron may review the order and select a confirm order button or link. As a result, the patron may be navigated to a pre-payment page, FIG. 9C, wherein payment or payment authorization may be received from the patron over the network 26 in any suitable manner. For example, the patron can input a payment by submitting credit or debit card data, a predetermined personal identification number, preauthorization of the patron's section, row, and seat, and/or any combinations(s) thereof. The payment page can be provided by the web host 22 and/or the third party enabler 24 in any suitable manner. FIG. 9C illustrates a concession order with the option of using PayPal® as the third party enabler 24. In another embodiment, the request from the roaming vendor may be an order for specific items with prices for example from a menu and may also include pre-payment, similar to the order concessions embodiment.

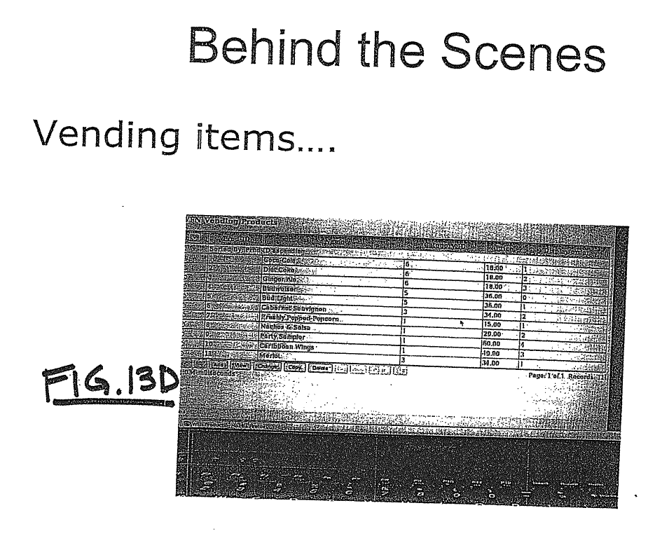

At step 220, a request or order for at least one of a product or service from a patron may be received by a vendor. For example, the request or order from step 218 may be received via the communications network 26 and vendor computers 16. In one embodiment, the request or order may be received as a text message, as exemplified by FIG. 12. In one embodiment, the text message may be generated by and routed from the administrator computers 14 over the network 26 to the vendor computers 16. In another embodiment, the text message may be generated by and routed from the patron computers 12 over the network 26 to the vendor computers 16. Step 220 also may include receiving the unique identifier of step 204 from the patron before fulfilling the request or order from the patron.

At step 222, the vendor may fulfill the request or order from the patron if the unique identifier received from the patron during step 220 corresponds to the unique identifier of step 204.

At step 224, a request or order confirmation may be communicated to the patron via the patron computer 12. For example, a text message may be sent to the patron computer 12 in any suitable manner. In one embodiment, the text message may be generated by and routed from the administrator computers 14 over the network 26 to the patron computers 12. In another embodiment, the text message may be generated by and routed from the vendor computers 16 over the network 26 to the patron computers 12.

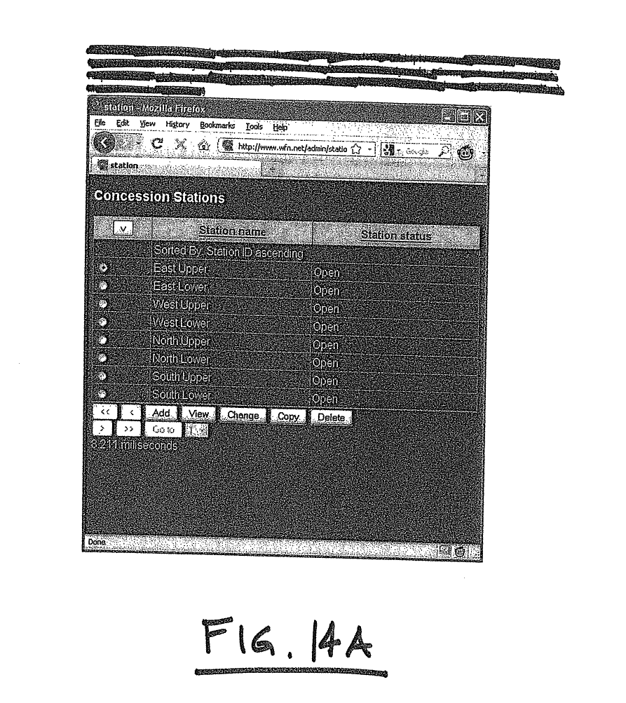

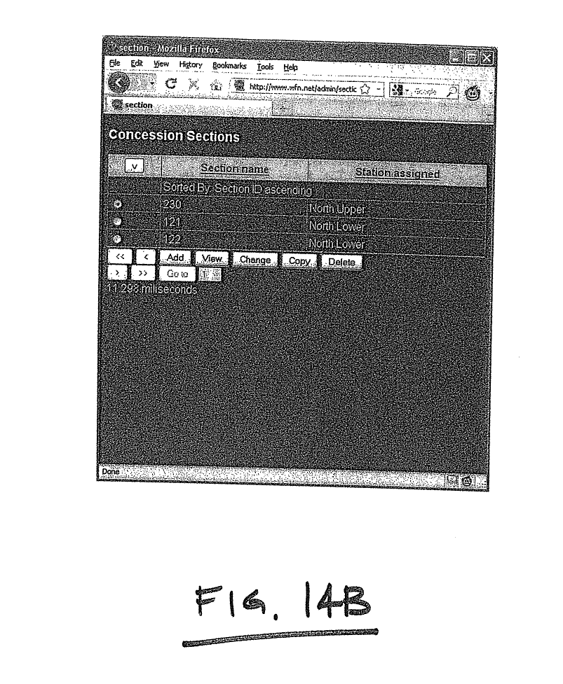

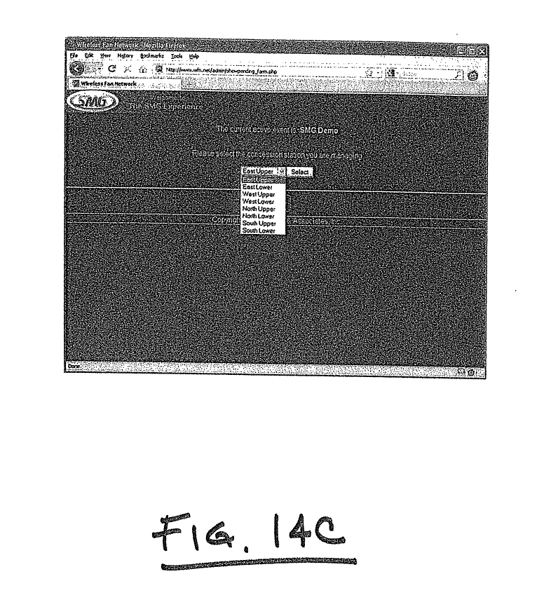

At step 225, the administrator or vendor computers 14, 16 may be able to alter the status of available concessions (e.g., food, beverage, and merchandise). For example, the status of available or active may be toggled with unavailable or inactive. The result of changing the status of item from available to unavailable at computers 14, 16 may be the removal of the item from any menus (e.g., the Order Concessions menu, the Suite Ordering Menu, and/or the Order Merchandise menu). In one embodiment, these items are no longer viewable by a patron. The capability of altering the availability or purchasability status of an item may be helpful in managing patron expectations; e.g., when the item is sold out or when alcoholic beverages are no longer available for purchase. See FIG. 13A.

At step 226, vendor requests and/or orders may be tracked. For example, as exemplified by FIGS. 13B and 13C, the administrator computers 14 may include a database, spreadsheet, or the like that is populated with requests and/or orders placed by the patrons.

Each request or order may be assigned a unique identifier and may include request or order information like patron location, ordered item, quantity, price, order status, and/or like information.

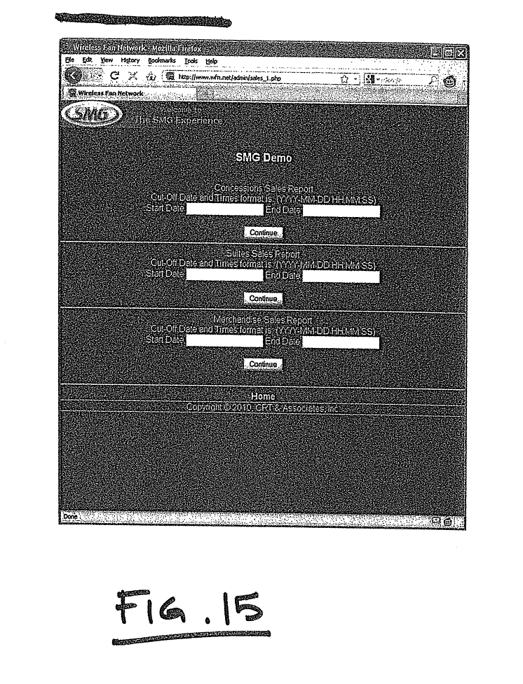

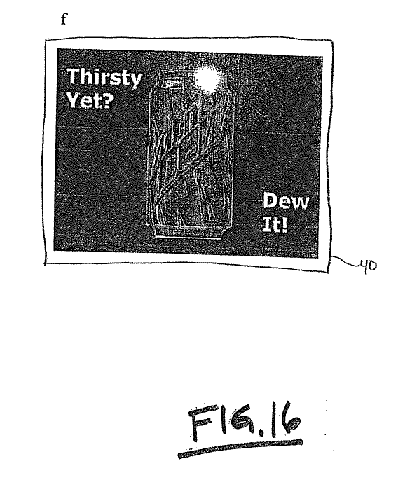

At step 228, requested and/or ordered vendor products may be tracked. For example, as exemplified by FIG. 13D, the administrator computers 14 may include a database, spreadsheet, or the like that is populated with items requested and/or ordered by the patrons. Each item may be assigned a unique identifier and may be associated with a category identification, quantity, prices, and/or like information. In addition, the input devices 42, 44 of the administrator computers 14 may be used to assign one or more defined areas or zones within the establishment to a selected vendor (e.g., one selling merchandise or concessions). These defined areas may include a quantity of seats, rows, sections, suites, or divisible areas. See FIG. 14A. Once assigned, the administrator computers 14 may display only the orders of patrons within the assignment. In one embodiment, the displayed orders may only be those which are currently pending (those orders that are incomplete or not filled). By way of example, the displayed orders may be arranged from the top-down as the oldest to the newest, and such displays may refresh the top-down listing periodically (e.g., every 10 seconds deleting or removing from view those orders which are complete or filled). The defined area also may be selectable and viewable from a listing of all defined areas within the establishment using the administrator computer 14. See FIGS. 14B and 14C.

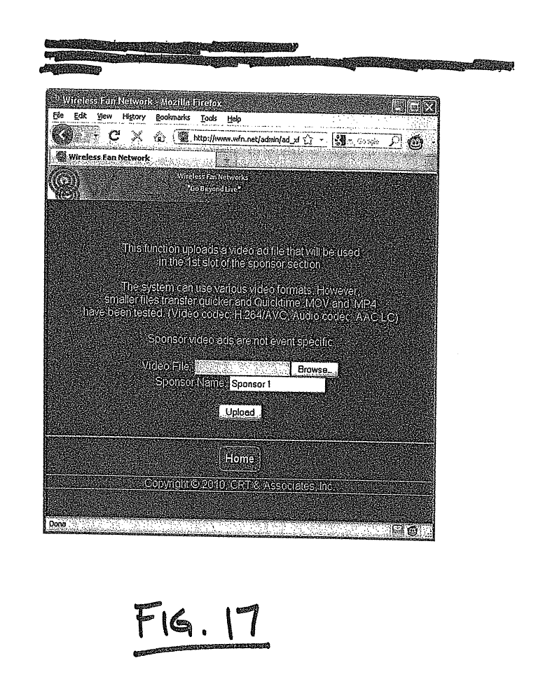

In addition to making assignments, the administrator computers 14 may generate revenue reports. The reports may include information based upon a selectable beginning date and end date, upon one or more areas or zones within the establishment, and/or quantities and/or categories of vended items. In addition, the reports may include sales and other data regarding third party enablers (e.g., PayPal®). In one example, a report may include concession stand sales and/or suite sales; and/or the report may further define whether the sales were sales of food, beverage, alcohol, and/or merchandise. See FIG. 15.

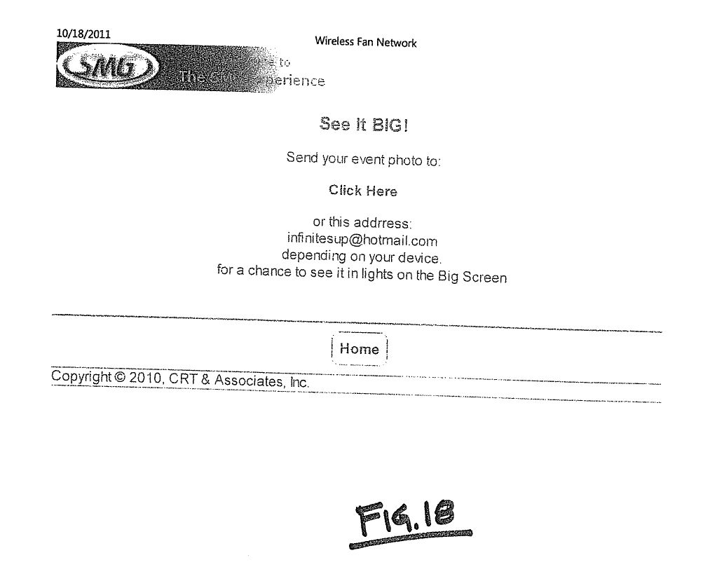

At step 230, at least one advertisement may be displayed to patrons on the patron computers 12 as patrons navigate between at least two of the user interface pages. The advertisement may be a still image or video. For example, as illustrated in FIG. 16, an advertisement may be displayed when a patron navigates from the main menu page of FIG. 5 to one of the request or ordering pages exemplified by FIGS. 8A, 9A, 10A or 11A. The advertisement may automatically appear for a predetermined period of time and then disappear before the selected service page appears. In one embodiment, the advertisement may be a substantially full screen advertisement, wherein a preponderance of the available screen area is occupied by the advertisement. In another embodiment, the advertisement varies between the pages, for example, so that a patron sees a first advertisement the first time the patron navigates from one page to another and a second, different advertisement another time the patron navigates between those same pages. In a further embodiment, a quantity of views of the advertisement is tracked for purposes of billing an advertiser. For example, the administrator computers 14 can track with a suitable database, spreadsheet or the like, the number of times any given patron, group of patrons, or all patrons were presented with a particular advertisement. The advertisements may or may not be event specific. The advertiser may or may not be a sponsor. In one embodiment, the advertisement may be an establishment announcement (e.g., ‘Alcoholic beverages will soon be no longer available for purchase’).

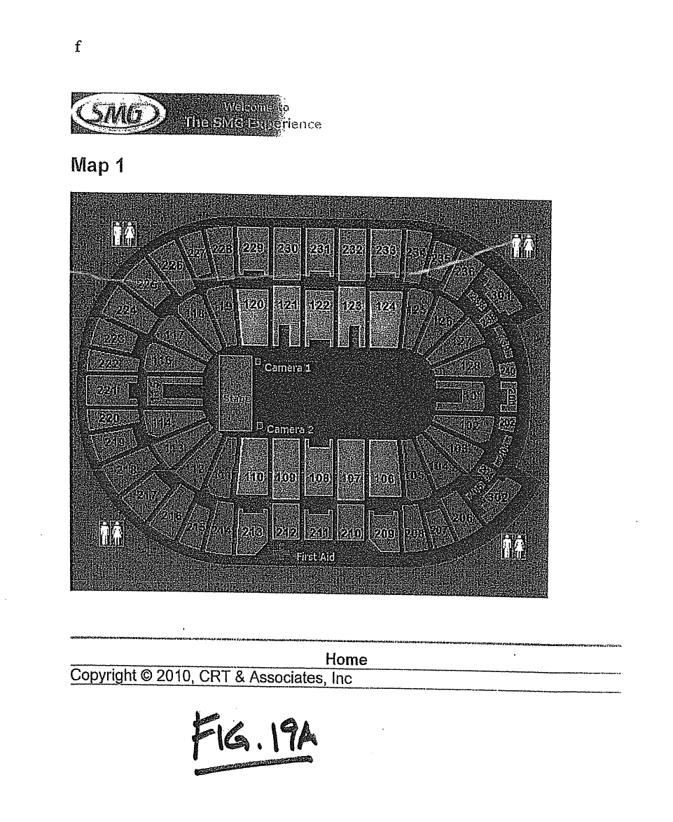

Still images and videos (including advertisements) may be uploaded and stored in memory 32 using administrator computers 14. In addition, images and video may be uploaded by third parties using third party computers 24 (e.g., the third party may be a sports marketing group). See FIG. 17. Still image advertisements may include: JPG, TIFF, PNG, GIF, BMP, etc. And video formats may include AVI, FLV, MOV, MP4, MPG, M2TS, MTS, RMVB, AVCHD, MKV, WebM(V8), QT, WMV, VOB, 3GP, 3GPP2, DivX, etc.

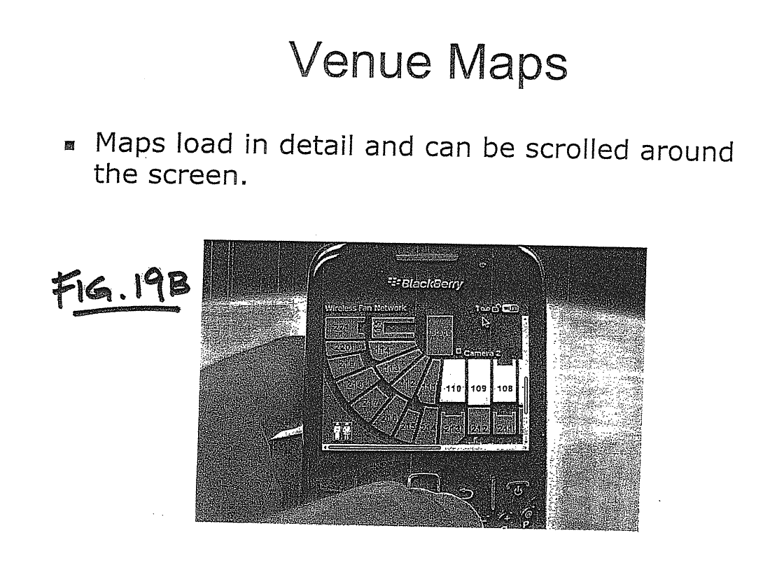

At step 232, data may be received from a patron via a patron computer and communications network. For example, the patron may capture a still photograph or video using the patron computer 12 or may compose a text message, and access a data upload page. In one embodiment, the patron may access the main menu page of FIG. 5 and select the Big Screen Photos. Upon selection, the patron may be navigated to the big screen photos page as exemplified by FIG. 18. The patron may then select a data upload feature and transmit the captured video and/or text message to another portion of the system 10 over the communications network 26 wherein it is then displayed on one or more displays at the establishment, or the patron may select an email option and email the still photograph or video to an administrator who may then upload the image or video. The data received from a patron may be censored or filtered for content; e.g., to remove profane or obscene subject matter.

At step 234, the data received from the patron at step 232 may be displayed on a video display at the establishment. For example, photographs taken or text messages composed by the patron may be displayed on one or more of the system output devices 20, which may include a video scoreboard, large video display board, video walls, or the like.

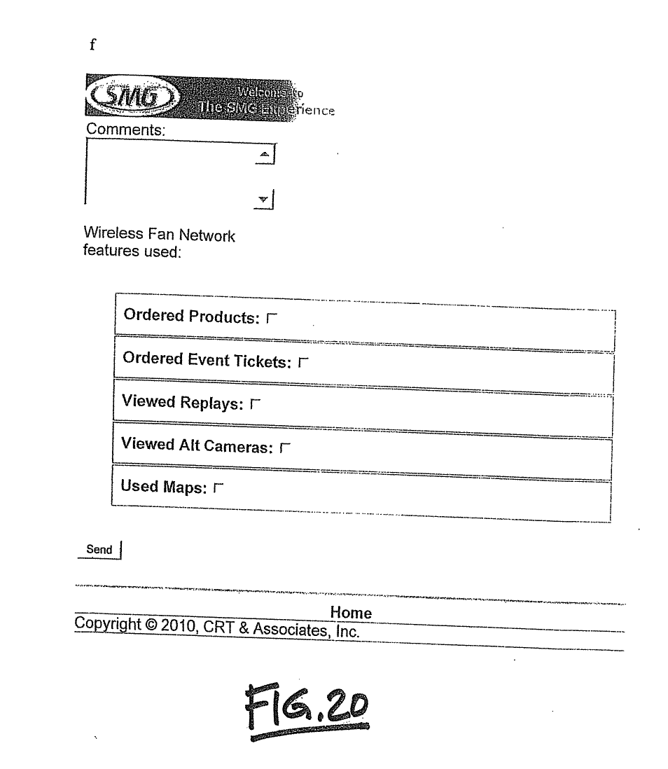

At step 236, a patron may select a establishment map for viewing. For example, the patron may access the main menu page of FIG. 5, select the Maps icon or text to navigate to a establishment maps page as exemplified by FIG. 19A, and then navigate a graphical map on the maps page including scrolling and zooming functions as exemplified by FIG. 19B.

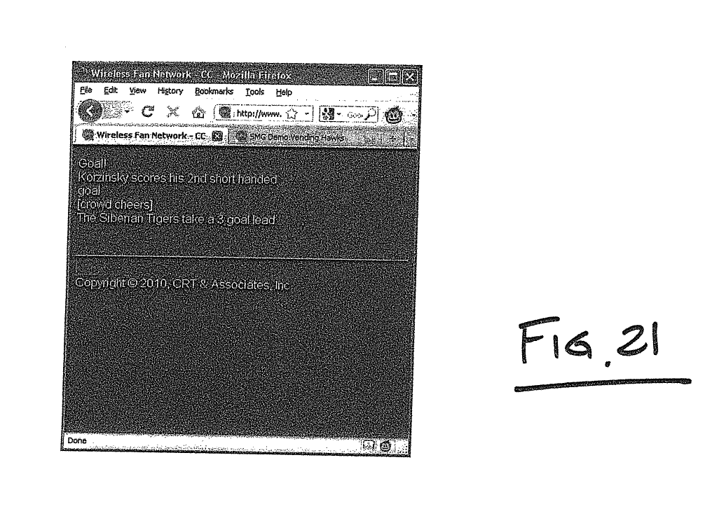

At step 238, a patron may submit feedback. For example, the patron may access the main menu page of FIG. 5, select the Feedback icon or text to navigate to a patron feedback page as exemplified by FIG. 20. Using the feedback page, the patron may submit text comments and check radio boxes to indicate system features that the patron used. Finally, the patron may select a send button or link to communicate the feedback to the system administrator.

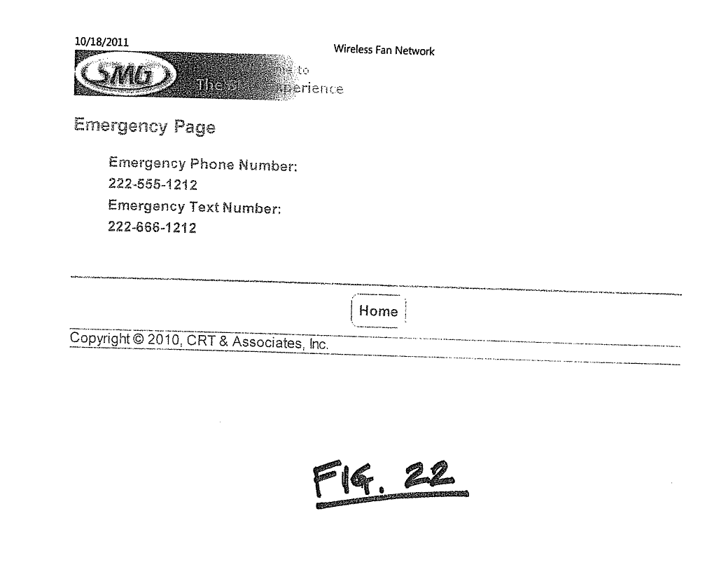

At step 240, a hearing impaired patron may select closed captioning of audio communicated at the establishment. For example, the patron may access the main menu page of FIG. 5, select the Closed Caption icon or text to navigate to a closed caption page as exemplified by FIG. 21. The patron may select event play-by-play, establishment announcements, and/or any other suitable closed captioning.

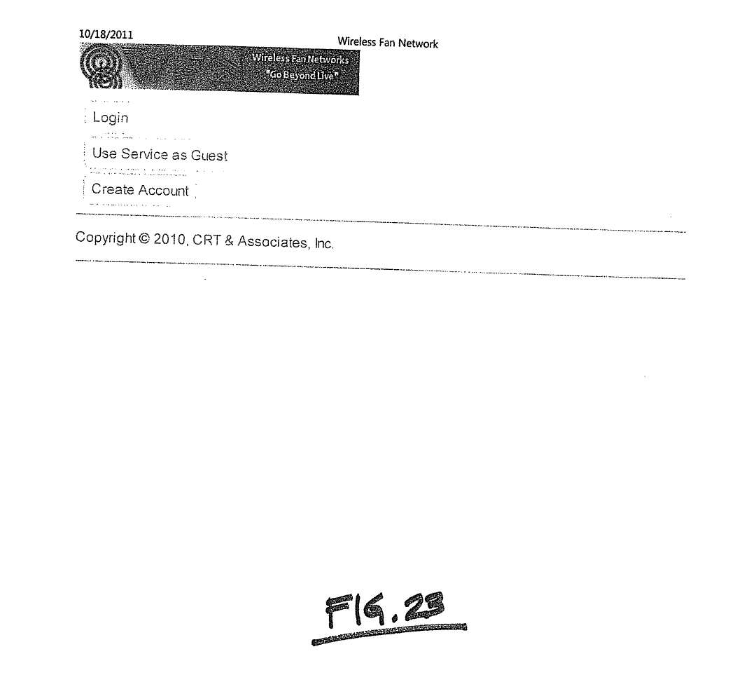

At step 242, a patron may obtain emergency assistance. For example, the patron may access the main menu page of FIG. 5, select the Emergency/Security icon or text to navigate to an Emergency page as exemplified by FIG. 22. In one embodiment, the Emergency page may display pre-stored general emergency information, real-time emergency information, and/or any other suitable emergency information. In another embodiment, the Emergency page may include data entry fields in which a patron may enter location information and/or emergency matter information. The location information may include section, row, and seat of an emergency. The emergency matter information fields may include defined matters selectable by the patron like apparent heart-attack, fainting, seizure, hit with puck, assault and battery, and the like, or may be free form for the patron to enter a specific emergency. The Emergency page also may include a send button or link to transmit data from the Emergency page to the network 26 for receipt by the administration computers 14 and/or an emergency vendor computer 16.

For example, a text message may be sent to the emergency vendor computer 16 in any suitable manner. In one embodiment, the text message may be generated and routed by the administration computers 14 over the network 26 to the vendor computer 16. In another embodiment, the text message may be generated by and routed from the patron computers 12 over the network 26 to the vendor computers 16.

At step 244, an emergency request confirmation may be communicated to the patron via the patron computer 12. For example, a text message may be sent to the patron computer 12 in any suitable manner. In one embodiment, the text message may be generated by and routed from the administrator computers 14 over the network 26 to the patron computers 12. In another embodiment, the text message may be generated by and routed from the vendor computers 16 over the network 26 to the patron computers 12.

At step 246, in response to receiving the data from the Emergency page, security, medical, and/or other emergency personnel may be automatically dispatched to the emergency location specified by the patron. The emergency request feature is particularly helpful for establishments where 911 telecommunications are not readily available to patrons and, thus, can speed arrival and preparation of emergency personnel.

At step 248, a patron may obtain a profile. For example, the patron may access the main menu page of FIG. 5 and select the Login/Profile text or icon. Upon selection, the patron is navigated to a login or profile page. An example of the login or profile page is illustrated at FIG. 23. At that page, the patron may select to login, obtain guest access, or create an account. When the patron selects login, the patron may be navigated to a page wherein the patron is prompted to provide an account identifier (e.g., a username or email address) and a unique identifier (e.g., a PIN). When the patron selects the guest account, the patron may be navigated back to the main menu page of FIG. 5. And when the patron's selection is to create an account, the patron may be navigated to an account information page wherein the patron is prompted to provide personal information (e.g., a username or email address), establishment location information (e.g., the section, row, and seat number of the patron or the patron's suite number, etc.), and/or a challenge question and its corresponding challenge answer. When a patron creates an account, the patron may save time later during an event when ordering concessions; e.g., food, beverages, and merchandise (e.g., the patron may access the system 10 and obtain service without repeatedly providing his or her establishment location).

The foregoing description is considered illustrative only. The terminology that is used is intended to be in the nature of words of description rather than of limitation. Many modifications and variations will readily occur to those skilled in the art in view of the description. Thus, the foregoing description is not intended to limit the invention to the embodiments described above. Accordingly the scope of the invention is defined by the appended claims.

What is claimed is:

1. A method of servicing patrons, comprising the steps of:
enabling access to a local wireless communications network at an establishment by a patron using a patron computer having a user interface including a video display;
storing a plurality of videos in memory;
receiving a request to view at least one of the stored plurality of videos from the patron via the patron computer user interface, which allows the patron to select among the videos; and
making available to the patron accessing the network, the requested stored video via the video display of the patron computer user interface.

2. The method of claim 1, further comprising the steps of:
capturing video of an event at the establishment;
communicating the captured video over the communications network as live video;
wherein the request of the receiving step includes a request for the live video.

3. The method of claim 2, further comprising the step of storing the captured video in memory, and wherein the request of the receiving step includes a request for the live video or the stored captured video.

4. The method of claim 1 wherein the stored plurality of videos is pre-recorded.

5. The method of claim 4 wherein the pre-recorded video is an advertisement.

6. The method of claim 5 wherein the advertisement is provided to the patron prior to the requested stored video being made available to the patron.

7. A method of servicing patrons using a communications network, comprising the steps of:
enabling access to the communications network by a patron using a patron computer having a user interface including a video display; and
receiving from the patron via the patron computer and communications network, a request for at least one of a product or service.

8. The method of claim 7 wherein the request is an order that includes at least one of a payment or payment authorization from the patron via the patron computer and communications network.

9. The method of claim 8 wherein the payment authorization is made using PayPal®.

10. The method of claim 8 wherein the order is placed with a concessions supplier.

11. The method of claim 10 wherein the order is a specific order for one or more particular products.

12. The method of claim 11 wherein the order is for delivery from a concessions stand and includes a location of the patron at the establishment.

13. The method of claim 11 wherein the order is for pick up from a concessions stand.

14. The method of claim 7 wherein the request includes a location of the patron at the establishment and is placed with a roaming vendor at the establishment.

15. The method of claim 14 wherein the request is for at least one general product type including at least one of beverage or snack.

16. The method of claim 7 wherein the request is received as a text message.

17. The method of claim 7 further comprising the step of transmitting a confirmation to the patron computer.

18. The method of claim 7 wherein the receiving step includes receiving at least one patron selection from a concessions menu accessible by the patron computer.

19. The method of claim 7 further comprising the steps of:
registering the patron in association with a seat location of the patron a unique identifier for the patron;
wherein the receiving step also includes receiving the unique identifier from the patron before fulfilling the request from the patron; and
fulfilling the request from the patron if the unique identifier received from the patron during the receiving step corresponds to the unique identifier of the registering step.

20. The method of claim 19 further comprising the step of providing the unique identifier to the patron again upon the patron's request when the patron has provided authenticating information.

21. The method of claim 20 wherein the authenticating information comprises at least one challenge answer to a challenge question.

22. The method of claim 7 further comprising the step of storing the request from the patron in memory to track patron requests by at least one of establishment section, establishment row, or establishment seat.

23. The method of claim 7 further comprising the step of communicating the request to a vendor computer, including a location of the patron.

24. The method of claim 23 wherein the communicating step includes sending a text message from the patron computer to the vendor computer.

25. The method of claim 7 wherein the request is a request for emergency assistance and includes a location of an emergency.

26. The method of claim 25 wherein the request is received as a text message.

27. The method of claim 25 further comprising the step of transmitting a confirmation to the patron computer.

28. A method of servicing patrons using a communications network, comprising the steps of:
enabling access to the communications network by a patron using a patron computer having a user interface including a video display;
providing a menu page of available services for viewing by the patron on the video display and a plurality of different user interface pages corresponding to the services; and
displaying at least one advertisement as the patron navigates between at least two of the pages.

29. The method of claim 28 wherein the at least one advertisement automatically appears for a predetermined period of time and then disappears.

30. The method of claim 28 wherein the at least one advertisement is a substantially full screen advertisement.

31. The method of claim 28 wherein the at least one advertisement varies between the pages.

32. The method of claim 28 wherein a quantity of views is tracked for purposes of billing an advertiser.

33. A method of servicing patrons using a communications network, comprising the steps of:
enabling access to the communications network by a patron using a patron computer having a user interface including a video display;
receiving from the patron via the patron computer and communications network, visual data; and
displaying the visual data received from the patron on a video display at the establishment.

34. The services method of claim 33 wherein the visual data is at least one of a photograph or video taken using the patron computer.

35. The services method of claim 33 wherein the visual data is a text message.

36. The services method of claim 33 further comprising a censoring step before the displaying step, wherein the visual data is censored.

37. A method of administering a patron service system, comprising the steps of:
enabling access to a local wireless communications network at an establishment by a plurality of patrons using patron computers having user interfaces that include video displays;
providing to the patrons, via the patron computers and communications network, menus having one or more products or services;
receiving from the patrons, via the patron computers and communications network, one or more requests for one or more products or services; and
processing sales transactions based upon the requests.

38. The method of claim 37 wherein the menu of products or services shown on the patron displays may be altered remotely by a system administrator via the communications network.

39. The method of claim 37 wherein the menu of products or services shown on the patron displays may be altered remotely by a vendor via the communications network.

40. The method of claim 37 wherein the requests of the receiving step originate from patrons assigned to one or more defined areas of the establishment.

41. The method of claim 40 wherein the defined areas include concession stand sales and suite sales.

42. The method of claim 37 further comprising the step of generating a revenue report based on one or more sales transactions.

43. The method of claim 42 wherein the report further includes selectable beginning and ending dates, selectable categories of products and services, and selectable defined areas.

44. The method of claim 37 wherein the one or more requests is received by a vendor computer, wherein the vendor computer displays pending orders arranged according to the time of receipt and wherein the completed orders are periodically removed from the display.

45. A computer program product including instructions on a computer-readable medium and executable by one or more computer processors of an establishment patron computer to cause the patron computer to implement the method of claim 1.

46. A computer program product including instructions on a computer-readable medium and executable by one or more computer processors of an establishment patron computer to cause the patron computer to implement the method of claim 7.

47. A computer program product including instructions on a computer-readable medium and executable by one or more computer processors of an establishment patron computer to cause the patron computer to implement the method of claim 28.

48. A computer program product including instructions on a computer-readable medium and executable by one or more computer processors of an establishment patron computer to cause the patron computer to implement the method of claim 33.

49. A computer program product including instructions on a computer-readable medium and executable by one or more computer processors of an establishment patron computer to cause the patron computer to implement the method of claim 37.

50. A computer program product including instructions on a computer-readable medium and executable by one or more computer processors of an establishment administrator computer to cause the establishment administrator computer to implement the method of claim 1.

51. A computer program product including instructions on a computer-readable medium and executable by one or more computer processors of an establishment administrator computer to cause the establishment administrator computer to implement the method of claim 7.

52. A computer program product including instructions on a computer-readable medium and executable by one or more computer processors of an establishment administrator computer to cause the establishment administrator computer to implement the method of claim 28.

53. A computer program product including instructions on a computer-readable medium and executable by one or more computer processors of an establishment administrator computer to cause the establishment administrator computer to implement the method of claim 33.

54. A computer program product including instructions on a computer-readable medium and executable by one or more computer processors of an establishment administrator computer to cause the establishment administrator computer to implement the method of claim 37.

55. A computer program product including instructions on a computer-readable medium and executable by one or more computer processors of an establishment vendor computer to cause the establishment vendor computer to implement the method of claim 1.

56. A computer program product including instructions on a computer-readable medium and executable by one or more computer processors of an establishment vendor computer to cause the establishment vendor computer to implement the method of claim 7.

57. A computer program product including instructions on a computer-readable medium and executable by one or more computer processors of an establishment vendor computer to cause the establishment vendor computer to implement the method of claim 28.

58. A computer program product including instructions on a computer-readable medium and executable by one or more computer processors of an establishment vendor computer to cause the establishment vendor computer to implement the method of claim 33.

59. A computer program product including instructions on a computer-readable medium and executable by one or more computer processors of an establishment vendor computer to cause the establishment vendor computer to implement the method of claim 37.

60. A system comprising the implementation of method claim 1.

61. A system comprising the implementation of method claim 7.

62. A system comprising the implementation of method claim 28.

63. A system comprising the implementation of method claim 33.

64. A system comprising the implementation of method claim 37.

65. An establishment administrator computer comprising the implementation of method claim 1.

66. An establishment administrator computer comprising the implementation of method claim 7.

67. An establishment administrator computer comprising the implementation of method claim 28.

68. An establishment administrator computer comprising the implementation of method claim 33.

69. An establishment administrator computer comprising the implementation of method claim 37.

70. An establishment vendor computer comprising the implementation of method claim 1.

71. An establishment vendor computer comprising the implementation of method claim 7.

72. An establishment vendor computer comprising the implementation of method claim 28.

73. An establishment vendor computer comprising the implementation of method claim 33.

74. An establishment vendor computer comprising the implementation of method claim 37.
